(19) United States
(12) Patent Application Publication
(10) Pub. No.: US 2011/0238960 A1
(43) Pub. Date: Sep. 29, 2011

(54) DISTRIBUTED PROCESSING SYSTEM, CONTROL UNIT, PROCESSING ELEMENT, DISTRIBUTED PROCESSING METHOD AND COMPUTER PROGRAM

(75) Inventors: Takayuki NAKATOMI, Tokyo (JP); Mitsunori KUBO, Tokyo (JP); Arata SHINOZAKI, Tokyo (JP)

(73) Assignee: OLYMPUS CORPORATION, Tokyo (JP)

(21) Appl. No.: 13/070,644

(22) Filed: Mar. 24, 2011

(30) Foreign Application Priority Data
Mar. 25, 2010 (JP) JP 2010-069735

(51) Int. Cl. G06F 9/30

(52) U.S. Cl. 712/225; 712/E09.016

(57) ABSTRACT

A distributed processing system has a control unit and a plurality of processing elements and includes a control line through which control information is sent and received between the control unit and the processing elements, and a data line through which data to be processed is transmitted from at least one selected from the control unit and the processing elements to the processing element connected thereto. The data line is independent from the control line. The processing element has a processing content changing section that changes the content of processing in the processing element using processing content changing information received through the control line when a monitored processing context of the processing element meets a processing content changing condition received through the control line.

### CROSS-REFERENCE TO RELATED APPLICATION

The present application is based upon and claims the benefit of priority from the prior Japanese Patent Application No. 2010-69735 filed on Mar. 25, 2010; the entire contents of which are incorporated herein by reference.

### BACKGROUND OF THE INVENTION

1. Field of the Invention

The present invention relates to a distributed processing system, and a control unit, a processing element, a distributed processing method and a computer program for the distributed processing system.

2. Description of the Related Art

In a multi-processor system, particularly in a data flow type multi-processor system in which n number of processing elements (n is an integer) are connected in a ring topology etc, data flows in one direction and is processed in the processing elements.

FIG. 42 is a diagram showing a configuration of a conventional data flow type multi-processor system in which the processing elements are connected in a ring topology. In the system, a control unit CU and n number of processing elements (processing element) PE1, PE2, . . . , PEn are connected in a ring topology. Data is transmitted from the control unit CU to the processing element PE1, in which the data is processed. The processed data is transmitted to the processing element PE2. The data is also processed in the processing element PE2 and subsequent processing elements PE, as with the processing element PE1. The data is transmitted from the last processing element PEn to the control unit CU.

For example, Japanese Patent Application Laid-Open No. 6-162228 discloses a processor apparatus in which a processing unit itself makes a determination for branching processing route.

PCT International Publication No. WO03/023602 discloses a system in which configuration data is sent to each of processing units through a third data transferring means and the connection status and/or the content of processing of processing units is changed based on the configuration data. In this system, the connection route or the content of processing of a processing unit can be changed independently from data processing in the processing unit.

### SUMMARY OF THE INVENTION

A distributed processing system according to the present invention has a control unit and a plurality of processing elements and comprises:

a control line through which control information is sent and received between the control unit and the processing elements; and

a data line through which data to be processed is transmitted from at least one selected from the control unit and the processing elements to the processing element connected thereto, the data line being independent from the control line,

wherein the processing element has a processing content changing section that changes the content of processing in the processing element using processing content changing information received through the control line when a monitored processing context of the processing element meets a processing content changing condition received through the control line.

A control unit according to the present invention controls two or more processing elements to cause them to perform distributed processing. The control unit is connected to the processing elements and comprises:

a control line through which control information is sent and received between the control unit and the processing elements; and

a data line through which data to be processed is transmitted to the processing element connected to the control unit, the data line being independent from the control line,

wherein the control unit sends a processing content changing condition and processing content changing information to the processing element through the control line.

A processing element according to the present invention is connected to two or more processing elements and performs distributed processing. The processing element comprises:

a control line through which control information is sent and received between the processing element and a control unit; and

a data line through which data to be processed is transmitted to the processing element from at least one selected from the control unit and the processing elements, the data line being independent from the control line, wherein

the processing element has a data processing section that processes input data and outputs the processed data,

the processing element receives a processing content changing condition and processing content changing information through the control line and monitors an information context concerning processing, and

the processing element has a processing content changing section that changes the content of processing in the processing element based on the processing content changing information when the information concerning processing meets the processing content changing condition.

A distributed processing method according to the present invention uses a control unit and a plurality of processing elements and comprises:

a control information sending/receiving step in which control information is sent and received between the control unit and the processing elements;

a processed data transmission step in which data to be processed is transmitted from at least one selected from the control unit and the processing elements to the processing element connected thereto, the processed data transmission step being independent from the control information sending/receiving step;

a data processing step in which input data is processed in and output from the processing element;

a step in which a content changing condition and processing content changing information are received by the control information sending/receiving step and a processing context is monitored; and

a processing content changing step in which the content of processing in the processing element is changed based on the processing content changing information when the processing context meets the processing content changing condition.

A program according to the present invention is a program for causing a computer to execute a distributed processing method using a control unit and a plurality of processing elements and comprises:

a control information sending/receiving function by which control information is sent and received between the control unit and the processing elements; and

a processed data transmission function by which data to be processed is transmitted from at least one selected from the control unit and the processing elements to the processing element connected thereto, the processed data transmission function being independent from the control information sending/receiving function, wherein the program causes the computer to executes the following functions:

a data processing function by which input data is processed in and output from the processing element;

a function by which a content changing condition and processing content changing information are received by the control information sending/receiving function and a processing context is monitored; and

a processing content changing function by which the content of processing in the processing element is changed based on the processing content changing information when the processing context meets the processing content changing condition.

### BRIEF DESCRIPTION OF THE DRAWINGS

FIG. 1A is a diagram showing a configuration in which control lines between a control unit and processing elements are connected in a ring topology;

FIG. 1B is a diagram showing a configuration in which control lines between a control unit and processing elements are connected in a bus topology;

FIG. 1C is a diagram showing a configuration in which control lines between a control unit and processing elements are connected in a star topology;

FIG. 2A is a diagram showing a configuration according to an embodiment in which data line and control line are separated from each other;

FIG. 2B is a diagram showing a conventional configuration in which data and control information are sent to a processing element through the same line;

FIG. 3 is a function block diagram of a distributed processing system;

FIG. 4 is a flow chart of data processing in a processing element PE;

FIG. 5 is a flow chart of processing concerning control information;

FIG. 6 is a diagram showing the structure of the control information;

FIG. 7 is a chart showing a sequence of creating a receiving port in a processing element;

FIG. 8A is a diagram showing a processing element PE before receiving a receiving port creation command;

FIG. 8B is a diagram showing the processing element PE after receiving a receiving port creation command;

FIG. 9 is a chart showing a sequence of creating a transmitting port in a processing element PE;

FIG. 10A is a diagram showing a processing element PE before receiving a transmitting port creation command;

FIG. 10B is a diagram showing the processing element PE after receiving a transmitting port creation command;

FIGS. 11A and 11B illustrate creation of a data line;

FIG. 12 is a diagram showing a processing element PE in which a receiving port and a transmitting port are not associated with each other;

FIG. 13 is a chart showing a sequence of associating a transmitting port and a receiving port with each other;

FIG. 14A is a diagram showing a processing element PE before receiving a transmitting port-receiving port association command;

FIG. 14B is a diagram showing the processing element PE after receiving a transmitting port-receiving port association command;

FIG. 15 illustrates transmitting port change;

FIG. 16 is a chart showing a sequence concerning a processing element configuration command;

FIG. 17 is a chart showing a sequence concerning a processing element information obtaining command;

FIG. 18 is a diagram showing the configuration of a distributed processing system according to a first embodiment;

FIG. 19 is a diagram showing a process of constructing a data line according to the first embodiment;

FIG. 20 is another diagram showing the process of constructing a data line according to the first embodiment;

FIG. 21 is still another diagram showing the process of constructing a data line according to the first embodiment;

FIG. 22 is a flow chart showing a data processing procedure in a processing element PE0;

FIG. 23 is a diagram showing the basic configuration of a distributed processing system according to a second embodiment;

FIG. 24 is a diagram showing an exemplary configuration of a system for detecting an object in a camera image by three parallel processes according to the second embodiment;

FIG. 25 is a diagram showing the configuration after the execution of a control command according to the second embodiment;

FIG. 26 is a diagram showing the configuration after the execution of control commands according to the second embodiment;

FIG. 27 is a diagram showing the configuration after the execution of control commands according to the second embodiment;

FIG. 28 is a diagram showing the configuration after the execution of control commands according to the second embodiment;

FIG. 29 is a diagram showing the configuration after the execution of control commands according to the second embodiment;

FIG. 30 is a diagram showing the configuration after the execution of control commands for dynamically changing a data line according to the second embodiment;

FIG. 31 is a diagram showing the configuration after the execution of control commands according to a first modification of the second embodiment;

FIG. 32 is a diagram showing the configuration after the execution of control commands according to the first modification of the second embodiment;

FIG. 33 is a diagram showing the configuration after the execution of control commands according to the first modification of the second embodiment;

FIG. 34 is a diagram showing the configuration after the execution of control commands according to a second modification of the second embodiment;

FIG. 35 is a diagram showing the configuration after the execution of a control command according to the second modification of the second embodiment;

FIG. 36 is a diagram illustrating a case in which a processing with a large load is divided into pre-processing and main processing and a bypass data line is created according to a third modification of the second embodiment;

FIG. 37 is a diagram illustrating a process in which control information CTINF is sent to a specific processing element PE3 according to a third embodiment;

FIG. 38A is a diagram illustrating a case in which a computation parameter of a processing element PE is changed through the control unit CU based on the control information from a processing element PE;

FIG. 38B is a diagram showing the relationship between the transmission bit rate and a coefficient k;

FIG. 39 is a flow chart of a process in which a computation parameter changing condition is sent from the control unit to a processing element;

FIG. 40 is a flow chart of data processing in a processing element PE3 for DCT and quantization;

FIG. 41 is a diagram showing a case in which control information is sent between processing elements PE, and a computation parameter is changed independently from the control unit CU; and

FIG. 42 is a diagram showing the configuration of a conventional data flow type distributed processing system.

### DETAILED DESCRIPTION OF THE INVENTION

In the following, embodiments of the distributed processing system, and the control unit, the processing element, the distributed processing method and the computer program for the distributed processing system according to the present invention will be described in detail with reference to the accompanying drawings. It should be understood that the present invention is not limited to the embodiments.

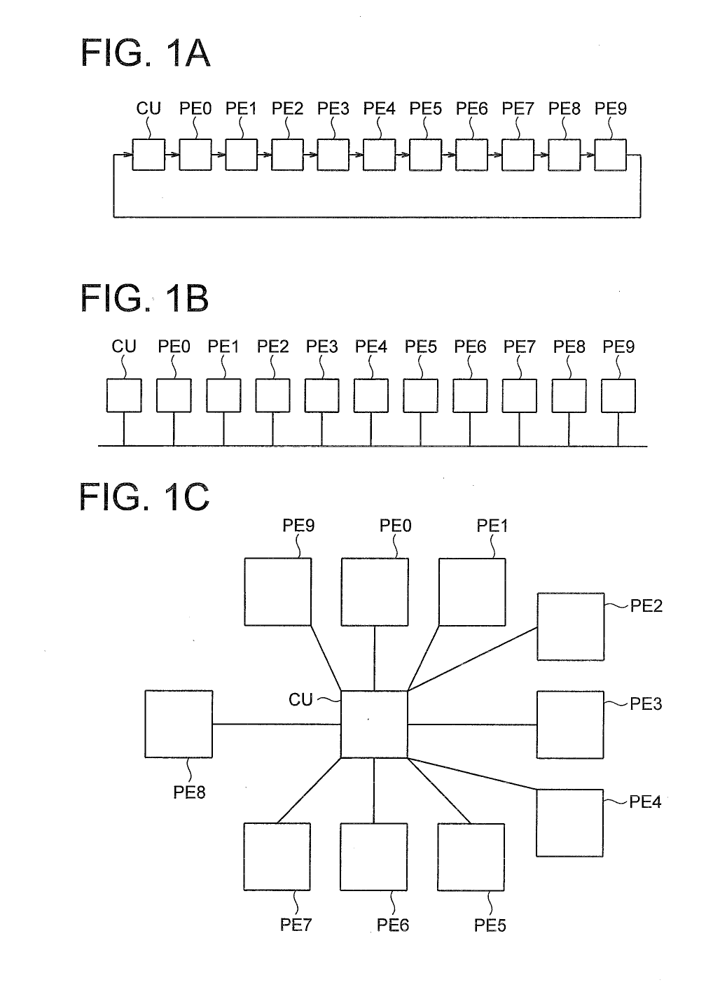

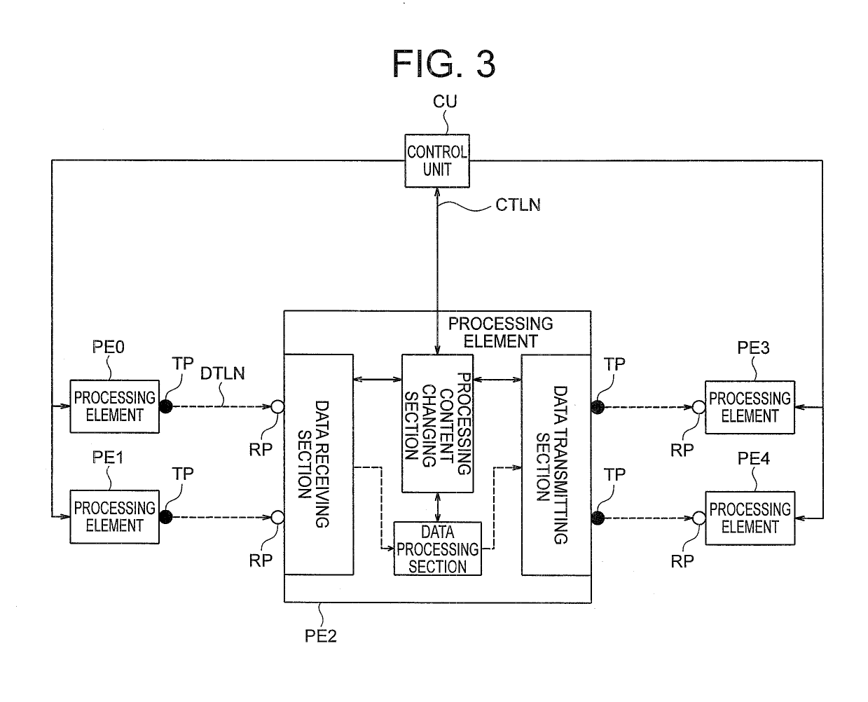

Firstly, the basic configuration of a distributed processing system according to an embodiment will be described. Details of the distributed processing system will be described later with reference to FIG. 3. FIGS. 1A, 1B, and 1C show examples of the basic configuration of the distributed processing system according to the present invention.

The distributed processing system includes a control unit CU and a plurality of processing elements, e.g. ten processing elements PE0, PE1, PE2, PE3, PE4, PE5, PE6, PE7, PE8, and PE9 (which will be hereinafter referred to as “processing elements PE0 to PE9”, “processing elements PE0 etc.” or “processing element (s) PE” arbitrarily), which are connected by control lines. The topology of the connection may be a ring topology shown in FIG. 1A, a bus topology shown in FIG. 1B, or a star topology shown in FIG. 1C.

In the state shown in FIGS. 1A to 1C, the line for transmitting/receiving data interconnecting the processing elements PE0 to PE9 has not been constructed yet. The control unit CU constructs the data line between the processing elements PE0 to PE9 through the control line based on the following control information.

Information transmitted through the control line will be referred to as control information. The control information sent from the control unit CU to the processing elements PE0 etc. includes (1) data line construction commands, (2) processing element configuration commands, and (3) processing element information obtaining commands.

The above (1) data line construction commands are classified into the following commands:

(1-1) receiving port creation commands;
(1-2) transmitting port creation commands;
(1-3) transmitting port-receiving port association commands;
(1-4) receiving port deletion commands;
(1-5) transmitting port change commands; and
(1-6) transmitting port deletion commands.

The content of the data line construction command is data line information. The data line information also includes information on transmitting and receiving ports and the association of the transmitting and receiving ports created in a processing element by the execution of a data line construction command. Combinations of (1) the data line construction command, (2) the processing element configuration command, and (3) the processing element information obtaining command enables transmitting data to the plurality of processing elements PE0 to PE9, receiving the processing result from the plurality of processing elements PE0 to PE9, and dynamically changing the transmission and reception.

The control unit CU sends the above commands to the processing elements PE0 to PE 9 through the control line to configure a line through which data is sent. Each of the processing elements PE0 to PE9 has a unique ID number. The control information is sent to the processing elements PE0 to PE 9 together with the ID numbers.

In the following descriptions, “processing element PE0”, for example, will refer to a processing element having an ID number of 0.

For example, if the control line is configured in a ring topology shown in FIG. 1C, each of the processing elements PE0 to PE9 accepts a command addressed to it and transfers a command not addressed to it to the next processing element PE.

The processing element PE that has received a receiving port creation command creates a port for receiving data. The processing element PE returns a receiving port number or an identifier identifying the created receiving port to the control unit CU.

The processing element PE that has received a transmitting port creation command creates a port for transmitting data. The processing element PE returns a transmitting port number or an identifier identifying the created transmitting port to the control unit CU.

The transmitting port creation command contains as parameters the ID of the processing element PE that should receive the data to be transmitted from the transmitting port and the receiving port identifier of the receiving port of this processing element. The transmitting port creation command also specifies whether transmission is to be done by broadcast or unicast.

The transmitting port-receiving port association command designates a receiving port identifier and a transmitting port identifier that have been created in a target processing element PE. Thus, the receiving port of the target processing element PE through which data is to be received and the transmitting port thereof through which data is to be transmitted after processed in the processing element are determined, namely the association between the receiving port and the transmitting port is established.

Desired data line can be constructed by appropriately sending the above-described commands from the control unit CU to the processing elements PE.

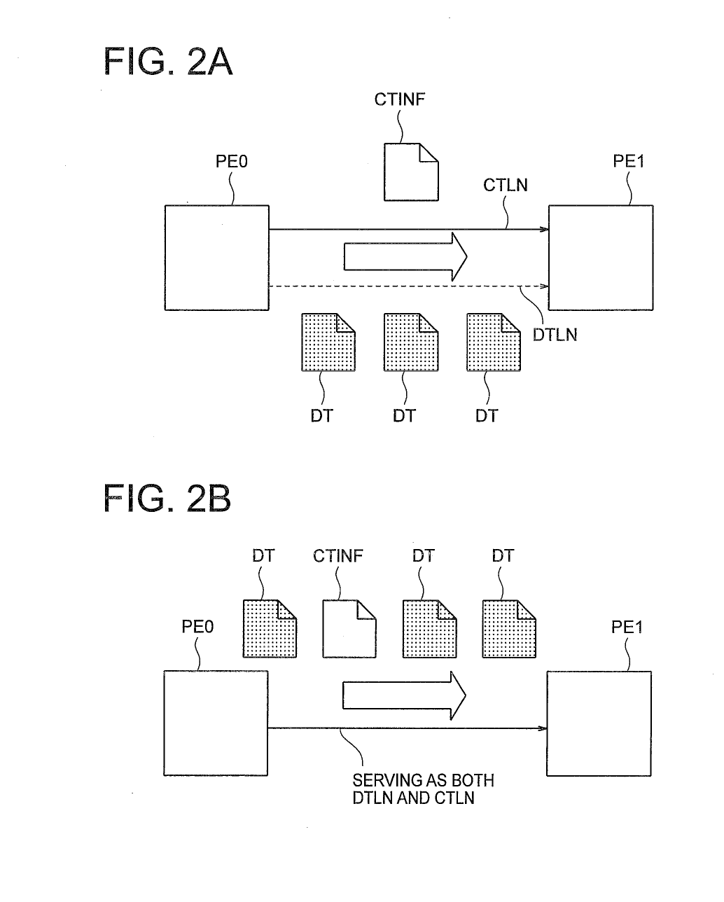

FIG. 2A shows a configuration of the distributed processing system according to the embodiment in which the data line and the control line are separated from each other. Data DT is sent from the processing element PE0 to the processing element PE1 through the data line DTLN. Control information CTINF is sent from the processing element PE0 to the processing element PE1 through the control line CTLN. The data line DTLN and the control line CTLN are lines independent from each other.

FIG. 2B shows a conventional configuration for sending data DT and control information CTINF to a processing element PE. Data DT and control information CTINF are sent from the processing element PE0 to the processing element PE1 through the same line serving as both the data line DTLN and the control line CTLN.

In the configuration according to the embodiment, while data DT is sequentially sent from the processing element PE0 to the processing element PE1, control information CTINF can be delivered to the specific processing element PE1 through the control line CTLN regardless of or independently from the load of data processing in the processing element PE0.

The control unit CU can newly create a data line DTLN during data processing in accordance with the amount of data that is transmitted through the data line DTLN or the load of data processing. The combined use of a processing element configuration command and a processing element information obtaining command that will be described in the following enables processing using a more optimized data line.

The processing element configuration command is used to change the operation of a processing element PE. For example, the processing element configuration command can be used to dynamically change an algorithm or a parameter of the process and to set a condition for changing the transmission destination in accordance with the content of data or the processing result. This allows the processing element PE to change the destination of data transmission in accordance with the content of processing.

Here, the dynamic changing of the processing algorithm includes, for example, switching between an algorithm with high processing speed and low accuracy and an algorithm with low processing speed and high accuracy. The dynamic changing of a parameter includes, for example, changing of a coefficient in a calculation formula.

The processing element information obtaining command is used by the control unit CU to obtain information about the processing element PE. The control unit CU sends a processing element information obtaining command to a designated processing element PE. Then, information about the processing element PE to which the command was sent is returned to the control unit CU.

The information about a processing element PE or processing context includes, for example, maximum reception rate [Bytes/sec], reception rate, maximum transmission rate, transmission rate, maximum electrical power consumption, electrical power consumption, maximum processing capability, and processing load.

The control unit CU can monitor the above-mentioned communication status or the processing status of a processing element PE by using a processing element information obtaining command. The control unit CU may send a processing element configuration command to a processing element PE, and the processing element PE that receives the processing element configuration command may send a processing context in accordance with the command. When this is the case, the processing element PE sends the obtained processing context of its own to other processing element(s) PE. Thus, each processing element PE can monitor the processing context of the other processing element (s). Namely, the use of the processing element configuration command enables the processing elements PE to dynamically monitor the processing context of the other processing elements independently from the control unit CU.

The control unit CU can change the data line DTLN so that another processing element PE different from the processing element PE of which information has been obtained is used, as needed.

FIG. 3 is a function block diagram of the distributed processing system. The control unit CU and a plurality of processing elements PE0, PE1, PE2, PE3, PE4 are connected by control line CTLN having a star topology drawn by solid line. The data flow is indicated by broken line.

The numeral in the reference symbol of the processing element PE (e.g. the numeral “0” in the “processing element PE0”) is the ID that identifies the processing element PE. For example, “processing element PE0” refers to a processing element having an ID of 0, and similarly “processing element PE1” refers to 4 processing element having an ID of 1.

Data is transmitted from the two processing elements PE0 and PE1 on the left in FIG. 3 to the processing element PE3 in the center of FIG. 3. The data is processed in the processing element PE2 in the center and transmitted to the two processing elements PE3 and PE4 on the right of FIG. 3.

The data line DTLN is constructed based on control information sent from the control unit CU to the processing elements PE0 to PE4. Therefore, the data line DTLN has not been connected yet in the initial state.

In order to achieve the effect of the present invention, it is preferred that the reception/processing of data DT and the reception/processing of control information CTINF can be performed independently from each other.

Since there is a possibility that the processing element PE receives data DT and control information CTINF at the same time and that the same processing block is accessed at the same time both in the course of processing of the data DT and in the course of processing of the control information, exclusive control for the reception/processing of the data DT and the reception/processing of the control information CTINF is needed.

A processing content changing section processes the control information received through the control line CTLN. The content of the processing varies according to the received control information. The processing content changing section configures an area for holding the setting of the processing content changing section itself, a data receiving section, and a data transmitting section based on the content of the control information.

The processing content changing section provides parameters necessary for data processing. The processing content changing section can send its own information to the control unit CU or other processing elements PE by dynamically sending the processing state of a processing element PE through the control line CTLN as well as make a response to the control information.

The data receiving section receives data through the data line DTLN. The data receiving section transfers the received data to the data processing section together with the receiving port number. The data receiving section sets a receiving port RP in accordance with an instruction from the processing content changing section. The data receiving section monitors statistical information such as the number of bytes of the data delivered to the receiving port RP and the recent reception rate [Bytes/sec] and provides the information thus collected to the processing content changing section in response to a request from it.

The data processing section processes the received data and transfers the processing result (i.e. resultant data) to the data transmitting section. In doing so, the data processing section accesses the processing content changing section to obtain parameters necessary for the processing. The information concerning data processing will be referred to as processing content changing information. The processing content changing information includes data line information (information on, for example, by which receiving port data is received and to which transmitting port the data is transmitted) and computation parameters (for example, a coefficient in a formula used in computation or a threshold). After processing the data, the data processing section transfers the processing result to the data transmitting section together with the transmitting port number. The data processing section monitors information concerning the processing when processing data, and provides the monitored information to the processing content changing section in response to a request from it. The information concerning the processing includes, for example, the load and the number of times of computation per second.

The data transmitting section transmits data through a designated transmitting port TP. The data transmitting section sets the transmitting port TP according to an instruction from the processing content changing section. The data transmitting section monitors statistical information such as the number of bytes of the data transmitted through the transmitting port TP and the recent transmission rate [Bytes/sec] and provides the monitored information to the processing content changing section in response to a request from it.

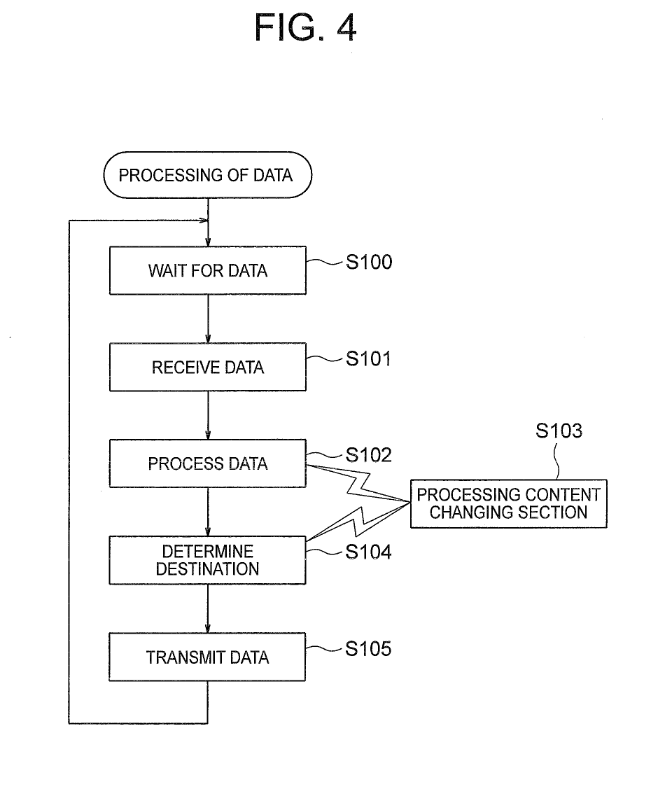

FIG. 4 is a flowchart of data processing in the processing element PE.

In step S100, the data receiving section is in a standby state, waiting for receiving data.

In step S101, the data receiving section receives data when the data comes to the receiving port of the data receiving section.

In step S103, the data processing section determines parameters and/or algorithm for processing with reference to the processing content changing section before processing the data. The parameters for processing include, for example, a coefficient in a formula and other factors.

In step S102, the content of the processing is determined, and then the data is processed.

In step S104, the processing content changing section determines the destination of transmission before the data processing section transmits the processing result. For example, the processing content changing section determines that the processing result is to be transmitted to the transmitting port with a port number of 0 if the computation result is equal to or higher than a predetermined threshold and the processing result is to be transmitted to the transmitting port with a port number of 1 if the computation result is lower than the predetermined threshold.

In step S105, after the destination is determined, the data processing section sends the transmitting port number and the data to the data transmitting section, and the data is transmitted.

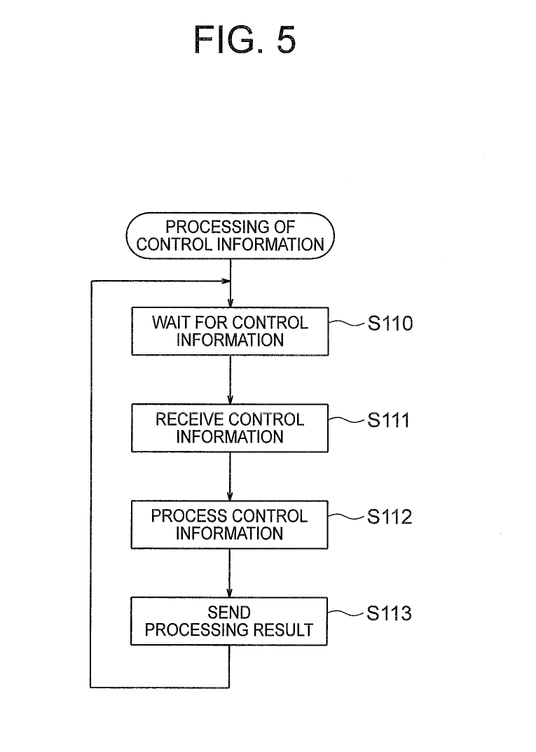

FIG. 5 is a flow chart of processing concerning control information.

In step S110, the processing content changing section is in a standby state, waiting for receiving control information.

In step S111, the processing content changing section receives the control information when it comes.

In step S112, when processing the control information, the processing content changing section analyzes the content of the control information and determines which control command the control information is. The processing content changing section executes processing according to the command based on the determination result.

In step S113, after the completion of the control information processing, the processing content changing section sends the result to the control unit CU through the control line CTLN.

In the following, the control commands will be described.

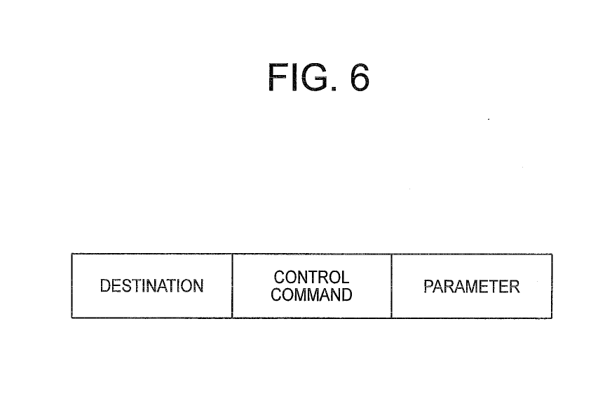

FIG. 6 shows the structure of the control information. The control information sent from the control unit CU to the processing element PE includes the destination, control command, and parameter.

The destination field contains the ID of the processing element PE to which the control information is to be sent. The control command is identified by a numeral. The content of the parameter depends on what the control command is.

The processing result is transferred from the next processing element PE to which the processing result has been transmitted to another and then to another etc. up until the last processing element PE. The last processing element PE sends the processing result to the control unit CU.

The topology of the connection of the control lines between the control unit CU and the processing elements PE is not limited to the ring topology, but it may be a bus topology or a star topology, as described above. Although five processing elements PE0 to PE4 are shown in FIG. 3, the number of the processing elements is not limited to this.

Thus, the control unit CU sends control information, which will be described in detail in the following, with appropriate parameters to the processing elements PE through the control line CTLN for transmitting control information CTINF. The control unit CU constructs the data line DTLN for transmitting the above-described data by sending the control information.

In the following, creation of a receiving port will be described.

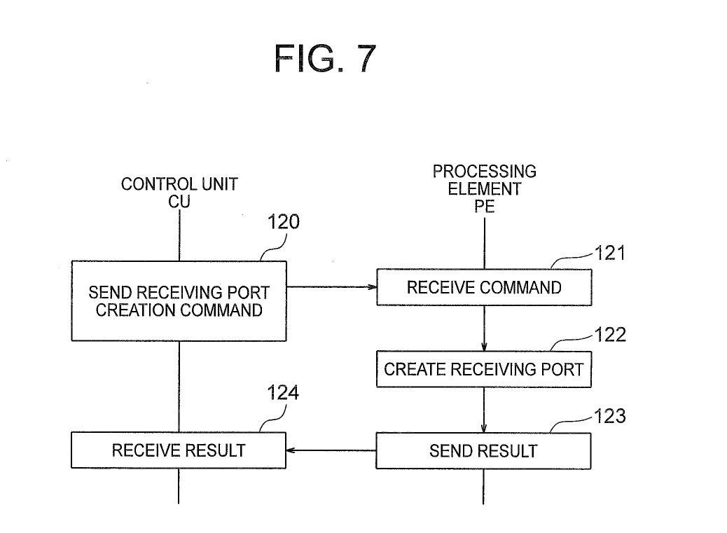

FIG. 7 is a chart of a sequence of creating a receiving port in a processing element PE.

In step 120 of the sequence, the control unit CU sends a receiving port creation command to a processing element PE in which a receiving port is to be created. The receiving port creation command is sent through the control line.

The processing content changing section of the processing element PE is waiting for a receiving port creation command sent from the control line. In step 121 of the sequence, the processing content changing section of the processing element PE receives the command sent from the control unit CU.

In step 122 of the sequence, the processing content changing section of the processing element PE accesses the data receiving section and causes it to create a receiving port based on the content of the receiving port creation command.

In step 123 of the sequence, if the creation of the receiving port is successful, the processing content changing section sends the receiving port number of the created receiving port as a result to the control unit CU. If the creation of the receiving port is unsuccessful, the processing content changing section sends a numerical value representing an error to the control unit CU.

After sending the receiving port creation command, the control unit CU is in a standby state, waiting for receiving the result from the processing element PE. In step 124 of the sequence, the control unit CU receives the result from the processing element PE.

Table 1 shows the content of the receiving port creation command.

TABLE 1

| | |
|---|---|
| parameter | number of ports to be created |
| return value | when successful: created receiving port number |
| | when unsuccessful: value (numeral) |
| | representing error |

The receiving port number is a unique number in a processing element PE. For example, in the case of communication using TCP (Transmission Control Protocol), a port number may be used as the receiving port number, and in the case where the processing element is hardware, the address of unused I/O port or the like may be used as the receiving port number. The receiving port number may be numerical values symbolically representing them. Here, it is assumed that the receiving port number is a numerical value starting from 0.

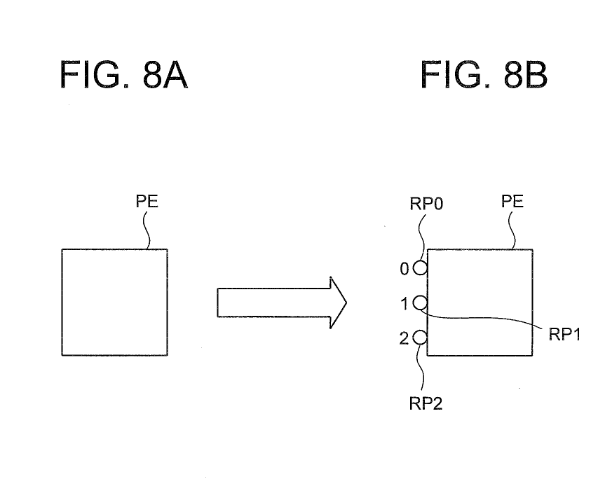

FIGS. 8A and 8B are diagrams showing a process of creating three receiving ports. FIG. 8A shows a processing element PE before receiving a receiving port creation command. FIG. 8B shows the processing element PE after receiving a receiving port creation command.

If the creation of the receiving ports is successful, three receiving ports RP0, RP1, and RP2 are created in the processing element PE as shown in FIG. 8B.

In all the accompanying drawings illustrating the embodiments, the receiving ports of the processing elements PE are represented by open circles. In some cases, a receiving port number is written next to a receiving port. For example, the numeral “0” written next to the receiving port RP0 in FIG. 8B is its receiving port number.

In the following, creation of a transmitting port will be described.

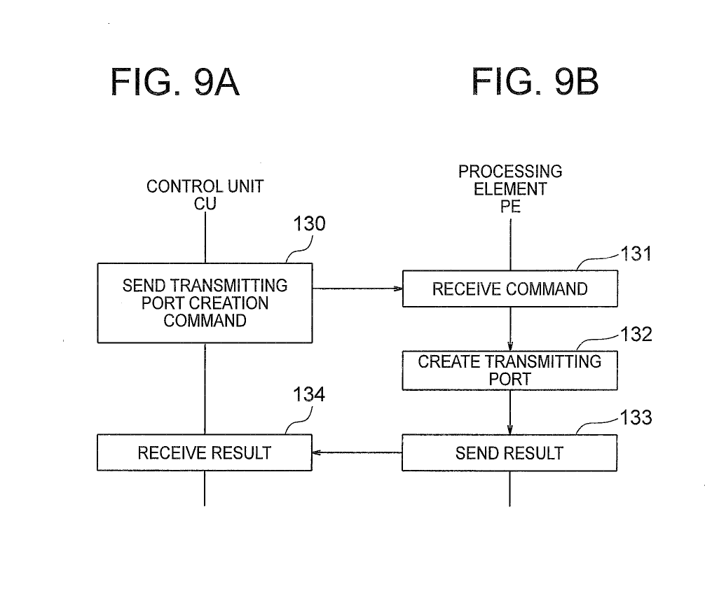

FIG. 9 is a chart of a sequence of creating a transmitting port in the processing element PE.

In step 130 of the sequence, the control unit CU sends a transmitting port creation command to a processing element PE in which a transmitting port is to be created.

In step 131 of the sequence, the processing content changing section of the processing element PE receives the transmitting port creation command.

In step 132 of the sequence, the processing content changing section of the processing element PE accesses the data transmitting section and causes it to create a transmitting port based on the transmitting port creation command.

In step 133 of the sequence, if the creation of the transmitting port is successful, the processing content changing section sends the port number of the created transmitting port to the control unit CU as a result. If the creation of the transmitting port is unsuccessful, the processing content changing section sends an error message to the control unit CU.

In step 134 of the sequence, the control unit CU receives the result from the processing element PE.

Table 2 shows the content of the transmitting port creation command.

TABLE 2

| | |
|---|---|
| parameter | ID of destination processing element, |
| | receiving port number of receiving side, and |
| | flag representing whether or not to use |
| | broadcast transmission |
| return value | when successful: created transmitting port |
| | number |
| | when unsuccessful: value (numeral) |
| | representing error |

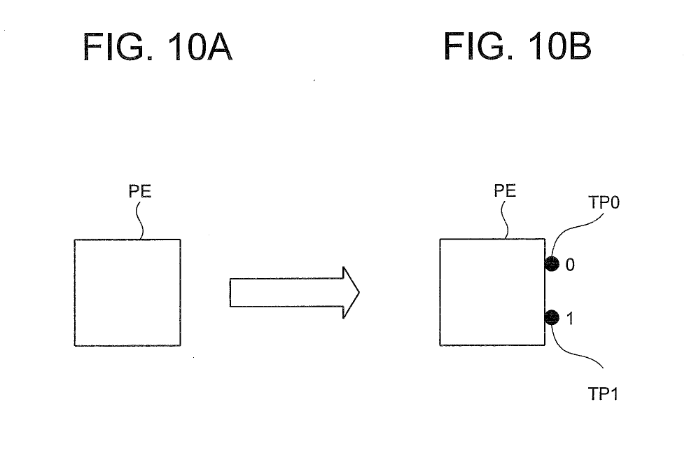

FIGS. 10A and 10B are diagrams showing a process of creating two transmitting ports. FIG. 10A is a diagram showing a processing element PE before receiving a transmitting port creation command. FIG. 10B is a diagram showing the processing element PE after receiving a transmitting port creation command.

If the creation of the transmitting ports is successful, two transmitting ports TP0 and TP1 are created in the processing element PE as shown in FIG. 10B.

In all the accompanying drawings illustrating the embodiments, the transmitting ports of the processing elements PE are represented by solid circles. In some cases, a transmitting port number is inscribed next to a circle representing a transmitting port. For example, the numeral “0” inscribed next to the transmitting port TP0 in FIG. 10B is the transmitting port number thereof.

When a transmitting port is created, the ID and the receiving port number of the processing element PE that will receive a transmission from the created transmitting port are designated. Thus, the processing element PE that will receive the transmission from the created transmitting port and the receiving port number of this processing element PE are determined. If broadcast communication is designated, data can be transmitted to a plurality of processing elements PE at the same time.

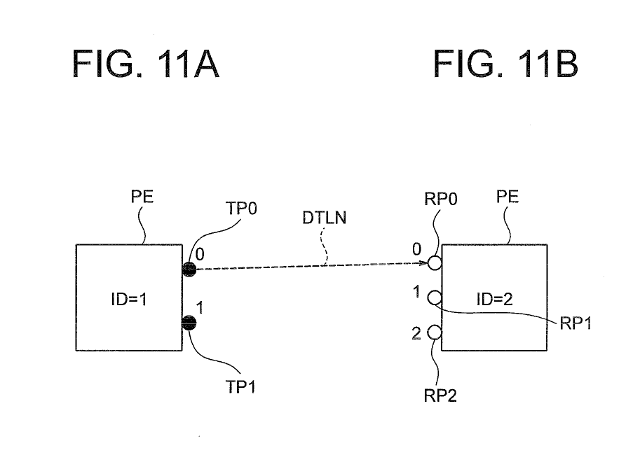

FIGS. 11A and 11B illustrate creation of a data line. FIGS. 11A and 11B illustrate an exemplary case in which data is transmitted from a transmitting port TP0 with a transmitting port number of 0 of a processing element PE having an ID of 1 to a receiving port RP0 with a receiving port number of 0 of a processing element PE having an ID of 2. In this case, a data line DTLN from the transmitting port TP0 to the receiving port RP0 is established.

In the following, association of a transmitting port and a receiving port will be described.

As described above, in a state in which only a transmitting port of a certain processing element PE1 and a receiving port of another processing element PE2 are connected with each other, it has not been determined, in one processing element, from which transmitting port the data received by a certain receiving port is to be transmitted. Therefore, the data can not be transmitted in this state.

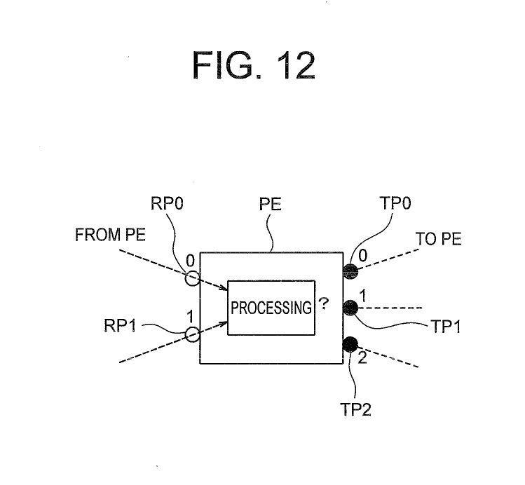

FIG. 12 shows a processing element PE in which the transmitting port from which the data received by a receiving port is to be transmitted has not been determined. In this state, the association of the receiving port and the transmitting port has not been defined yet, namely it has not been defined to which transmitting port TP among the transmitting ports TP0, TP1 and TP2 the data received by the receiving port RP0 is to be transferred after processed has not been defined yet.

Therefore, it is necessary to determine from which transmitting port the data received by a receiving port is to be transmitted after processed, in other words, it is necessary to associate the receiving port number and the transmitting port number with each other.

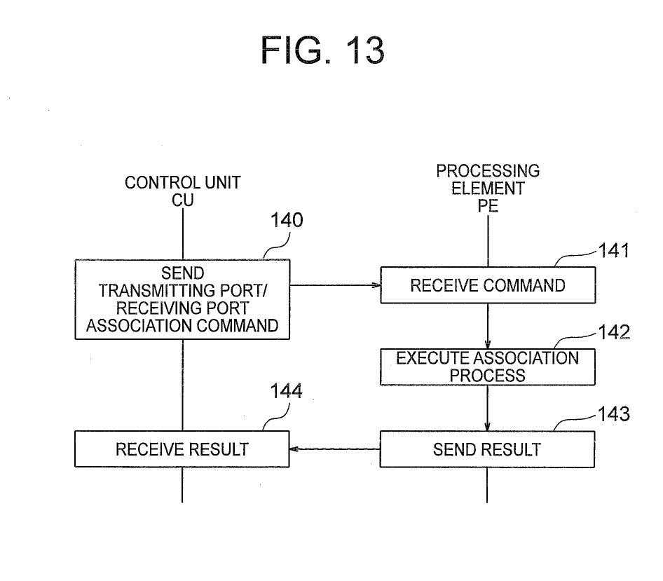

FIG. 13 is a chart of a sequence of associating a transmitting port and a receiving port with each other.

In step 140 of the sequence, the control unit CU sends a transmitting port-receiving port association command to a processing element PE in which a transmitting port and a receiving port are to be associated with each other. The transmitting port-receiving port association command is sent through the control line CTLN.

The processing content changing section of the processing element PE waits for a command sent through the control line. In step 141 of the sequence, the processing content changing section of the processing element PE receives the command from the control unit CU.

In step 142 of the sequence, the processing content changing section of the processing element FE checks whether or not parameters are correct based on the content of the transmitting port-receiving port association command and sets the association.

In step 143 of the sequence, the processing content changing section of the processing element PE sends a code representing the result of the association, namely a code representing whether the association between the receiving port and the transmitting port has been successfully achieved or failed, to the control unit CU.

After sending the transmitting port-receiving port association command, the control unit CU is in a standby state, waiting for the result from the processing element PE. In step 144 of the sequence, the control unit CU receives the result from the processing element PE.

Table 3 shows the content of the transmitting port-receiving port association command.

TABLE 3

| | |
|---|---|
| parameter | receiving port number(s) and transmitting port |
| | number(s) |
| return value | success or failure (e.g. error code represented |
| | by numerical value) |

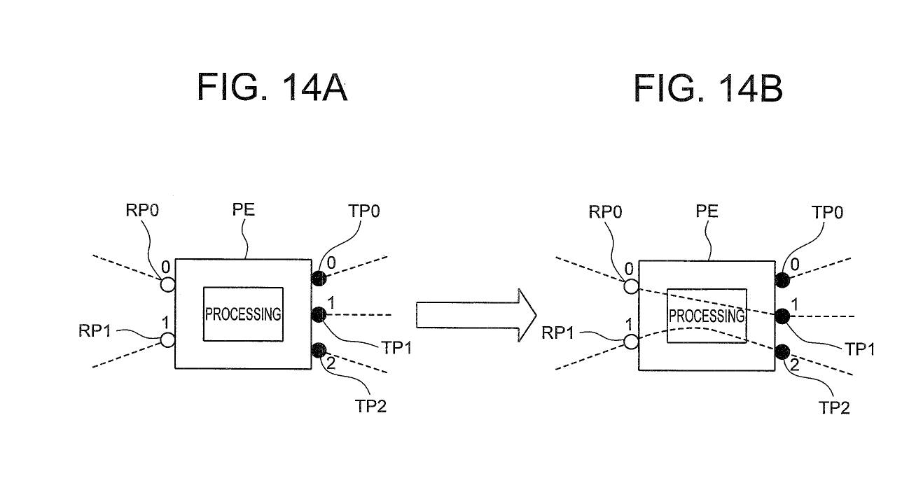

FIGS. 14A and 14B illustrate an exemplary association between transmitting ports and receiving ports. FIG. 14A is a diagram showing a processing element PE receiving a transmitting port-receiving port association command. FIG. 14B is a diagram showing the processing element PE after receiving a transmitting port-receiving port association command.

As shown in FIG. 14A, the processing element PE has receiving ports RP0 and RP1 and transmitting ports TP0, TP1, and TP2. In the state shown in FIG. 14A, the association between the receiving ports and the transmitting ports is not defined.

With a transmitting port-receiving port association command, the input at the receiving port RP0 is associated with the output at the transmitting port TP1. Furthermore, with this transmitting port-receiving port association command, the input at the receiving port RP1 is also associated with the output at the transmitting port TP2.

In consequence, the data input through the receiving port RP0 and processed is transferred to the transmitting port TP1, and the data input through the receiving port RP1 and processed is transferred to the transmitting port TP2. Thus, the receiving ports and the transmitting ports in the processing element PE are associated with each other.

When a receiving port number that has been associated with a transmitting port number is designated, the association is overwritten. If a receiving port number is not associated with any transmitting port number, no data is transmitted.

In the following, deletion of a receiving port will be described.

If a processing element PE receives a receiving port deletion command, the processing element PE deletes a receiving port created in it. When a receiving port is deleted, the association of the transmitting port(s) and the receiving port(s) set for the deleted receiving port is also deleted.

Table 4 shows the content of the receiving port deletion command.

TABLE 4

| | |
|---|---|
| parameter | receiving port number(s) |
| return value | success or failure (e.g. error code represented |
| | by numerical value) |

In the following, transmitting port change will be described.

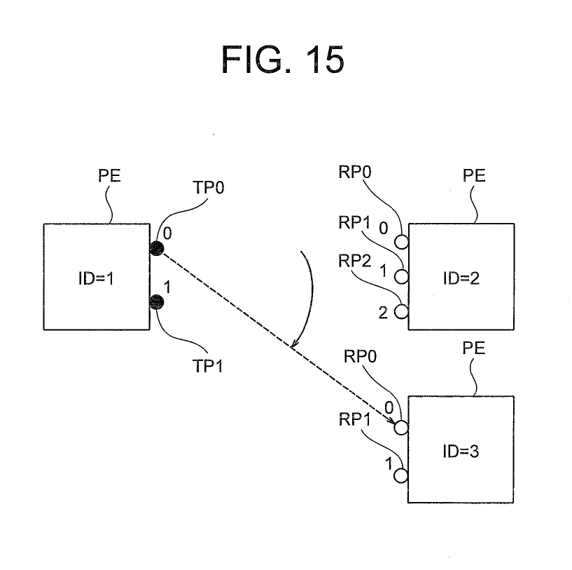

FIG. 15 illustrates the transmitting port change. FIG. 15 shows an exemplary case in which the destination of transmission from a transmitting port TP0 with a transmitting port number of 0 of a processing element PE having an ID of 1 is changed from a receiving port RP0 having a receiving port number of 0 of a processing element PE having an ID of 2 to a receiving port RP0 having a receiving port number of 0 of a processing element PE having an ID of 3.

In this way, the transmitting port change command is used to change the destination of transmission from an existing transmitting port.

Table 5 shows the content of the transmitting port change command.

TABLE 5

| | |
|---|---|
| parameter | existing transmitting port number, ID of |
| | destination processing element after change, |
| | receiving port number of receiving side, and |
| | flag representing whether or not to use |
| | broadcast transmission |
| return value | when successful: transmitting port number |
| | after change (same as transmitting port number |
| | given in the parameter) |
| | when unsuccessful: value (numeral) |
| | representing error |

In the following, deletion of a transmitting port will be described.

A transmitting port deletion command is used to delete a transmitting port created in a processing element PE. When a transmitting port is deleted, the association of the transmitting port(s) and the receiving port(s) set for the deleted transmitting port is also deleted.

Table 6 shows the content of the transmitting port deletion command.

TABLE 6

| | |
|---|---|
| parameter | transmitting port number(s) |
| return value | success or failure (e.g. error code represented |
| | by numerical value) |

In the following, configuration or setting of a processing element will be described.

A processing element PE configuration command is used to change the operation of a processing element PE. The content of the parameters depends on the processing element PE. For example, in a processing element PE for executing DCT (Discrete Cosine Transform) is implemented an algorithm with high processing speed and low accuracy and an algorithm with low processing speed and high accuracy, which are assumed to be adapted to be switched according to the situation.

The algorithm to be used can be set by the processing element configuration command. The processing element (PE) configuration command is used to determine which algorithm is to be used. A processing element PE that executes quantization is adapted to receive a quantization table from the control unit CU. Possible configurations of the processing elements PE are written in the specifications of the processing elements. The control unit CU knows the content of the specifications of the processing elements PE and performs configuration of the processing elements PE using a processing element configuration command.

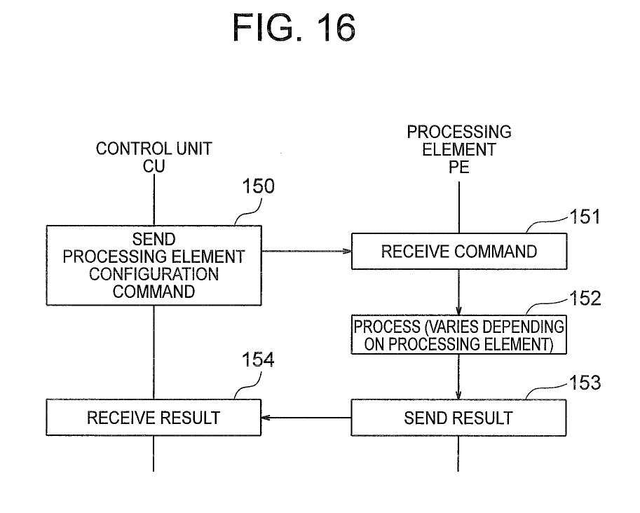

FIG. 16 is a chart of a sequence concerning the processing element configuration command.

In step 150 of the sequence, the control unit CU sends a processing element (PE) configuration command to a processing element PE.

In step 151 of the sequence, the processing element PE receives the processing element configuration command.

In step 152 of the sequence, the processing content changing section of the processing element PE processes the received processing element configuration command if possible.

In step 153 of the sequence, the processing element PE sends a return value representing the result of the configuration to the control unit CU.

After sending the processing element configuration command, the control unit CU is in a standby state, waiting for receiving the result from the processing element PE. In step 154 of the sequence, the control unit CU receives the result from the processing element PE.

Table 7 shows the content of the processing element configuration command.

TABLE 7

| | |
|---|---|
| parameter | various parameters (depending on processing |
| | element PE) |
| return value | various values (depending on processing |
| | element PE) |

For example, in the case of a processing element PE that executes the quantization, a quantization table, a multiplying factor for the table, and/or a reference value for determining the table value are sent as the processing element configuration command. The processing content changing section stores these data in a memory, for use in data processing. The processing element PE sends the processing result to the control unit PE.

In the following, obtainment of the processing element information will be described.

A processing element information obtaining command is used by the control unit CU to obtain the status of a processing element PE. The control unit CU can change the data line DTLN based on the obtained information on the processing element PE. The control unit CU can obtain the information shown in Table 8 by the processing element information obtaining command.

TABLE 8
information

maximum reception rate [Bytes/sec]
reception rate [Bytes/sec]
maximum transmission rate [Bytes/sec]
transmission rate [Bytes/sec]
maximum electrical power consumption [W]
electrical power consumption [W]
maximum processing capability
processing load

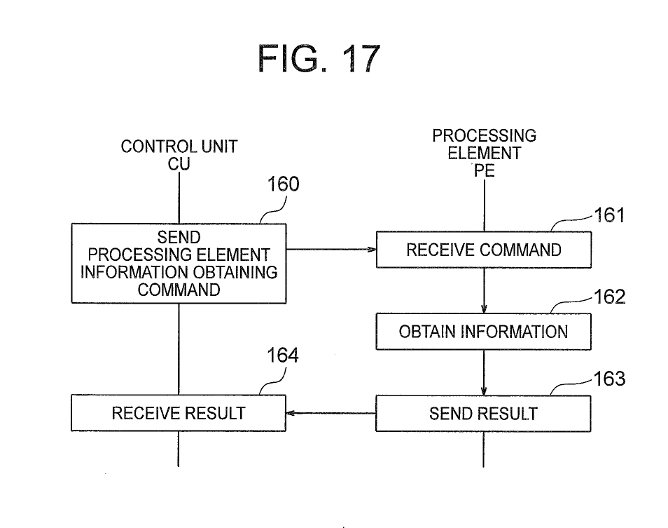

FIG. 17 is a chart of a sequence concerning the processing element information obtaining command.

In step 160 of the sequence, the control unit CU sends a processing element information obtaining command to a processing element PE.

In step 161 of the sequence, the processing element PE receives the processing element information obtaining command. In step 162 of the sequence, the processing content changing section of the processing element PE processes the received processing element information obtaining command if possible.

In step 163 of the sequence, the processing element PE sends information as a return value to the control unit CU.

After sending the processing element information obtaining command, the control unit CU is in a standby state, waiting for receiving the result from the processing element PE. In step 164 of the sequence, the control unit CU receives the result, or processing element information, from the processing element PE.

Table 9 shows the content of the processing element information obtaining command.

TABLE 9

| | |
|---|---|
| parameter | N.A. |
| return value | information |

Here, the unit of the processing capability varies depending on the function of processing elements PE. For example, the unit of the processing capability of the processing element PE for executing DCT is DCT/sec that represents the number of times the processing element PE executes the DCT in one second.

The control unit CU can change the data line DTLN based on the information obtained using the processing element information obtaining command.

If there are a plurality of processing elements PE that can provide same processing and a processing element PE that has higher maximum processing capability becomes available after the process has been started, the control unit CU may change the data line DTLN. Thus, it is possible to make use of the processing element PE that has higher maximum processing capability.

Furthermore, if a processing element PE of lower power consumption is added after the process has been started, the processing element PE of lower power consumption may be used to reduce the power consumption.

If no response is made to the processing element information obtaining command, the control unit CU determines that the processing element PE that does not make a response is out of order. Then, the control unit CU may change the data line DTLN to use another processing element PE.

In the above description, it is described that the control unit CU obtains information on a processing element PE by actively sending a processing element information obtaining command to a processing element PE. However, the way of obtaining processing element information is not limited to this, but a processing element PE may actively send its own information through the control line CTLN.

The control unit CU can configure a processing element PE using the processing element configuration command in such a way that the processing element PE sends its own information through the control line CTLN at regular intervals or when something changes. Then, the processing element PE is adapted to send its own information actively through the control line CTLN.

### First Embodiment

A distributed processing system according to a first embodiment of the present invention will be described. The first embodiment provides an exemplary data line configuration for displaying a still image.

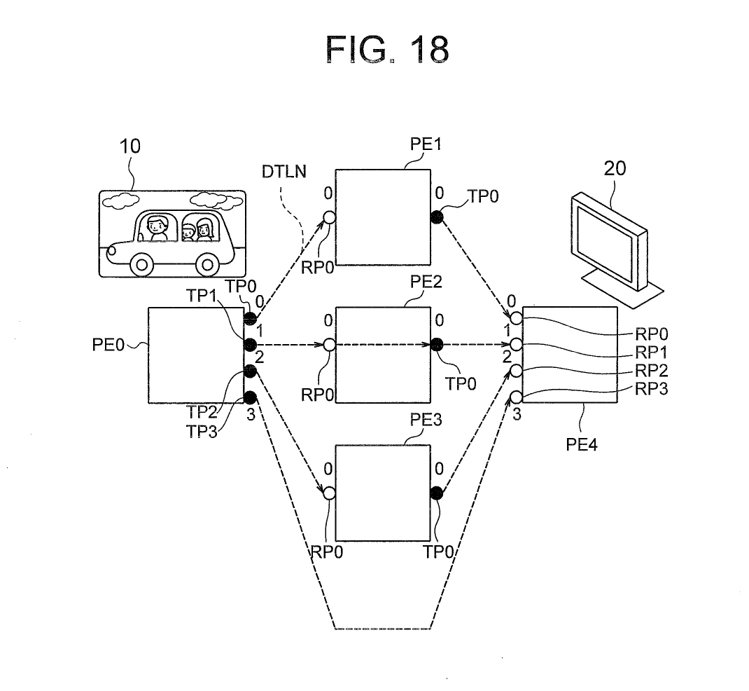

FIG. 18 is a diagram showing the configuration of a distributed processing system according to the first embodiment. A procedure of constructing data line using a data line construction command for constructing the configuration of processing elements PE0, PE1, PE2, PE3, and PE4 shown in FIG. 18 will be described.

Table 10 shows specifications of the processing elements PE0, PE1, PE2, PE3, and PE4.

TABLE 10

| | function of | | |
|---|---|---|---|
| | processing | | |
| ID | element PE | input | output |
| 0 | determination | image | image |
| | of image | | |
| | format | | |
| 1 | decompression | JPEG image | bitmap |
| | of JPEG image | | |
| 2 | decompression | Gif image | bitmap |
| | of Gif image | | |
| 3 | decompression | PNG image | bitmap |
| | of PNG image | | |
| 4 | image display | bitmap | image display |
| | | | (not output to |
| | | | data line) |

The processing elements PE0 to PE4 of which specifications are shown in Table 10 are connected in the way shown in FIG. 18. Thus, data line for displaying a still image of any format input to the processing element PE0 on a monitor 20 connected to the processing element PE4 is constructed.

The processing element PE0 determines the format type by analyzing the format of the input still image 10. The determination is made based on the header of the data constituting the image. The processing element PE0 selects a next processing element PE based on the determination result, and transmits the image to the selected processing element PE.

It is assumed that the types of format that can be determined or identified include only the following three types.

JPEG (Joint Photographic Experts Group)

Gif (Graphic Interchange Format)

PNG (Portable Network Graphics)

The processing elements PE1, PE2, and PE3 decompress the input image, convert the image into a bitmap represented by 8-bit RGB, and transmit it to the processing element PE4.

The processing element PE4 displays the input bitmap image on the monitor 20. If an image of unknown format is input to the processing element PE0, the image is directly sent to the processing element PE4. However, the processing element PE4 expects that the received data is a bitmap image. Therefore, if an image of unknown format is sent to the processing element PE4, a still image is not displayed correctly on the monitor 20.

It is assumed that the control unit CU obtains and knows in advance the IDs of the processing elements PE0 to PE4, the functions provided by the processing elements PE0 to PE4, the data types capable of being processed by the processing elements PE0 to PE4, and the output formats of the processing elements PE0 to PE4.

In order to obtain the information on the processing elements PE0 to PE4 in advance, a database in which information on the processing elements PE0 to PE4 are stored may be provided inside or outside the control unit CU, and the information may be read out from it. Alternatively, the information may be given by a user who operates the control unit CU and knows the information. Still alternatively, the processing elements PE may be adapted to send information on them to the control unit CU when they are connected to the control line. The control unit CU may send a processing element information obtaining command to the processing elements PE0 to PE4 to cause them to send the information in response to the command. In the last case, it is necessary that the destination of the processing element information obtaining command be indicated by a specific value representing broadcast, e.g. all bits are 1.

Table 11 shows control information sent from the control unit CU to the processing elements PE0 to PE4 when constructing data line for still image display. In the “command” section of Table 11, “receiving” refers to a receiving port creation command, “transmitting” refers to a transmitting port creation command, “association” refers to a transmitting port-receiving port association command, and “configuration” refers to a processing element configuration command.

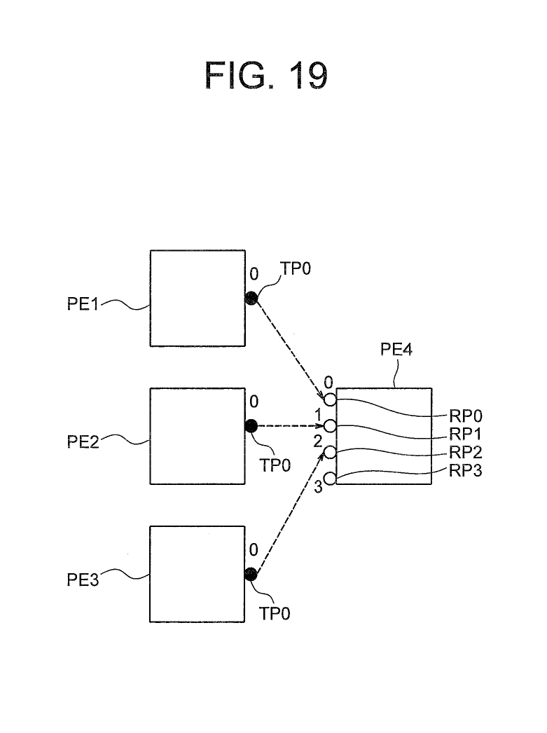

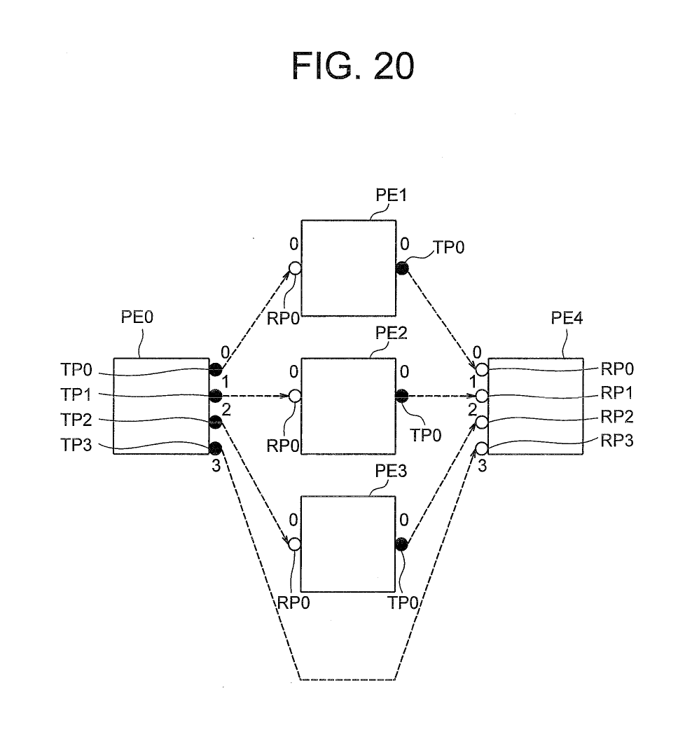

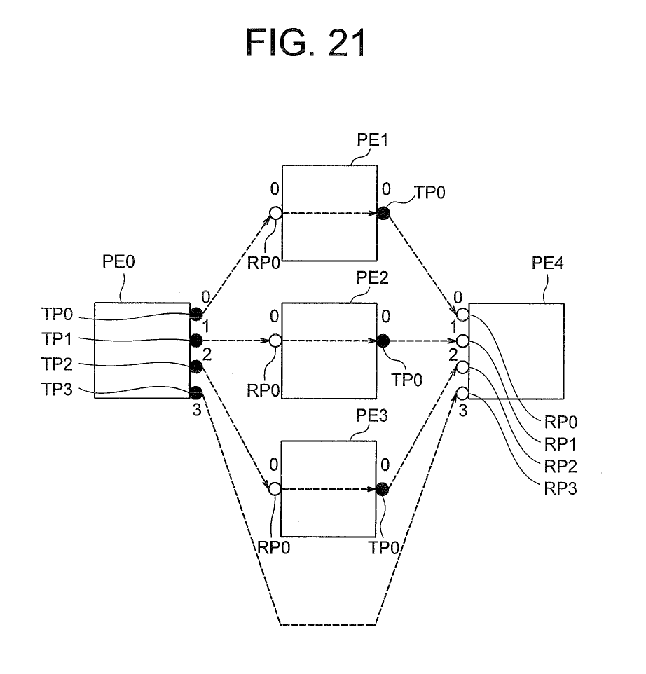

TABLE 11

| | | | | | data line |
|---|---|---|---|---|---|
| | | | | | after |
| number | destination | command | parameter | return value | processing |
| 1 | 4 | receiving | number of | receiving | configuration |
| | | | receiving | port numbers | shown in FIG. 19 |
| | | | ports to be | 0, 1, 2, 3 | |
| | | | created: 4 | | |
| 2 | 1 | transmitting | destination | transmitting | configuration |
| | | | processing | port number 0 | shown in FIG. 19 |
| | | | element PE: 4 | | |
| | | | receiving | | |
| | | | port number: 0 | | |
| | | | broadcast: No | | |
| 3 | 2 | transmitting | destination | transmitting | configuration |
| | | | processing | port number 0 | shown in FIG. 19 |
| | | | element PE: 4 | | |
| | | | receiving | | |
| | | | port number: 1 | | |
| | | | broadcast: No | | |
| 4 | 3 | transmitting | destination | transmitting | configuration |
| | | | processing | port number 0 | shown in FIG. 19 |
| | | | element PE: 4 | | |
| | | | receiving | | |
| | | | port number: 2 | | |
| | | | broadcast: No | | |
| 5 | 1 | receiving | number of | receiving | configuration |
| | | | receiving | port number 0 | shown in FIG. 20 |
| | | | ports to be | | |
| | | | created: 1 | | |
| 6 | 2 | receiving | number of | receiving | configuration |
| | | | receiving | port number 0 | shown in FIG. 20 |
| | | | ports to be | | |
| | | | created: 1 | | |
| 7 | 3 | receiving | number of | receiving | configuration |
| | | | receiving | port number 0 | shown in FIG. 20 |
| | | | ports to be | | |
| | | | created: 1 | | |
| 8 | 0 | transmitting | destination | transmitting | configuration |
| | | | processing | port number 0 | shown in FIG. 20 |
| | | | element PE: 1 | | |
| | | | receiving | | |
| | | | port number: 0 | | |
| | | | broadcast: No | | |
| 9 | 0 | transmitting | destination | transmitting | configuration |
| | | | processing | port number 1 | shown in FIG. 20 |
| | | | element PE: 2 | | |
| | | | receiving | | |
| | | | port number: 0 | | |
| | | | broadcast: No | | |
| 10 | 0 | transmitting | destination | transmitting | configuration |
| | | | processing | port number 2 | shown in FIG. 20 |
| | | | element PE: 3 | | |
| | | | receiving | | |
| | | | port number: 0 | | |
| | | | broadcast: No | | |
| 11 | 0 | transmitting | destination | transmitting | configuration |
| | | | processing | port number 3 | shown in FIG. 20 |
| | | | element PE: 4 | | |
| | | | receiving | | |
| | | | port number: 3 | | |
| | | | broadcast: No | | |
| 12 | 1 | association | receiving | success | configuration |
| | | | port number: 0 | | shown in FIG. 21 |
| | | | transmitting | | |
| | | | port number: 0 | | |
| 13 | 2 | association | receiving | success | configuration |
| | | | port number: 0 | | shown in FIG. 21 |
| | | | transmitting | | |
| | | | port number: 0 | | |
| 14 | 3 | association | receiving | success | configuration |
| | | | port number: 0 | | shown in FIG. 21 |
| | | | transmitting | | |
| | | | port number: 0 | | |
| 15 | 0 | configuration | transmission | success | configuration |
| | | | route to be | | shown in FIG. 21 |
| | | | used for | | |
| | | | determined | | |
| | | | type of data | | |
| | | | are: | | |
| | | | for JPEG; | | |
| | | | transmission | | |
| | | | route number 0 | | |
| | | | for Gif; | | |
| | | | transmission | | |
| | | | route number 1 | | |
| | | | for PNG; | | |
| | | | transmission | | |
| | | | route number 2 | | |
| | | | for other | | |
| | | | data; | | |
| | | | transmission | | |
| | | | route number 3 | | |

FIG. 19 is a diagram showing the configuration after the execution of the commands 1 to 4 shown in Table 11. The control unit CU sends the receiving port creation command 1 to the processing element PE4. Then, four receiving ports RP0, RP1, RP2, and RP3 are created in the processing element PE4 according to the command 1.

The control unit CU sends the transmitting port creation commands to the processing elements PE1, PE2, and PE3. Then, a transmitting port TP0 is created in each of the processing elements PE1 to PE3 according to the commands.

FIG. 20 is a diagram showing the configuration after the execution of the commands 5 to 11 shown in Table 11. The control unit cu sends the receiving port creation commands 5, 6, and 7 to the processing elements PE1, PE2, and PE3 respectively. Then, a receiving port RP0 is created in each of the processing elements PE1, PE2, and PE3 according to the commands 5, 6, and 7.

The control unit CU sends the transmitting port creation commands 8, 9, 10, and 11 shown in Table 11 to the processing element PE0. Then, transmitting ports TP0, TP1, TP2, and TP3 are created in the processing element PE0 according to the commands 8, 9, 10, and 11.

FIG. 21 is a diagram showing the configuration after the execution of the commands 12 to 15 shown in Table 11. The control unit CU sends the transmitting port-receiving port association commands 12, 13, and 14 to the processing elements PE1, PE2, and PE3 respectively. Then, the receiving port RP0 is associated with the transmitting port TP0 in each of the processing elements PE1, PE2, and PE3 according to the commands 12, 13, and 14.

The control unit CU sends the processing element configuration command 15 to the processing element PE0. Then, a value representing the determination result is set in the processing element PE0 according to the command 15.

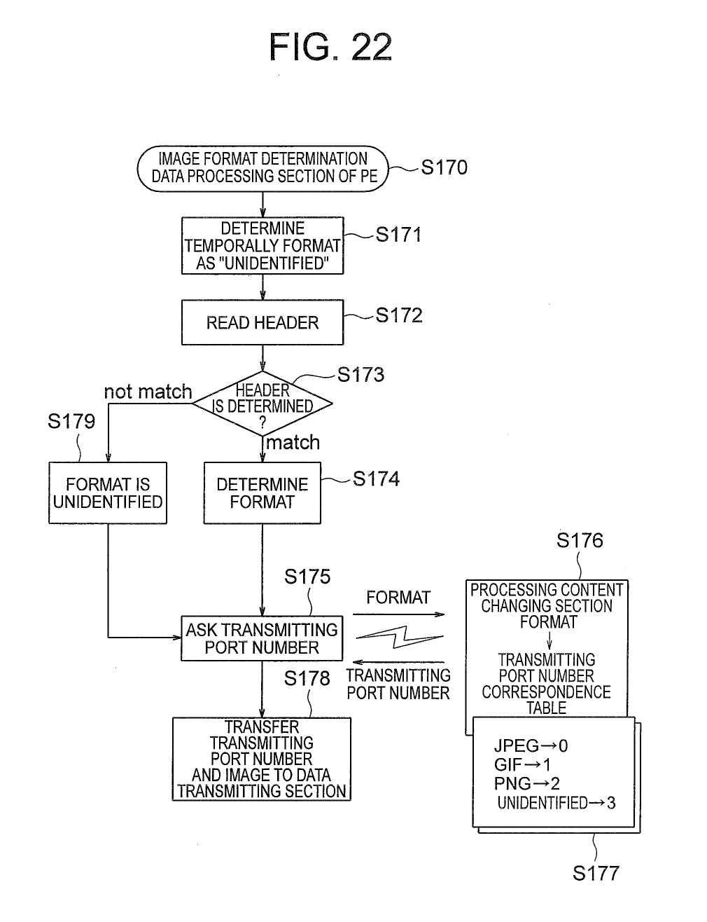

FIG. 22 is a flow chart of the data processing procedure in the processing element PE0.

The control unit CU sets a table specifying the correspondence between format and transmitting port number in the processing element PE0 in advance using the processing element configuration command.

An image is given to the data processing section of the processing element PE0. The image may be provided from either the control unit CU or the memory of the processing element PE0.

The image data is transferred from the data receiving section to the data processing section. At first, in step S171, the format determination result is set to “unidentified”.

In step S172, the data processing section reads the header of the image data.

In step S173, the data processing section refers to the header. If, for example, the image data is a JPEG file, the data processing section determines that the data is a hexadecimal digit sequence starting with 0xff 0xd8.

If the format of the image is determined to be one of the identifiable formats, namely JPEG, Gif, and PNG formats, the data processing section determines the format of the image in step S174.

In step S175, if the format of the image has been determined, the data processing section asks the processing content changing section about the transmitting port number corresponding to the format thus determined.

In step S176, the processing content changing section returns the transmitting port number to the data processing section based on the format and the table specifying the correspondence between format and transmitting port number that has been set in advance by the processing element configuration command.

The content of the table specifying the correspondence between format and transmitting port number is shown in FIG. 22 as S177. For example, if the format of the image is determined to be JPEG, the processing content changing section returns the transmitting port number 0 to the data processing section.

In step S178, the data processing section transfers the received data and the transmitting port number to the data transmitting section.

If the format of the image is determined not to be any one of the identifiable formats, namely JPEG, Gif, and PNG formats, the data processing section determines that the format of the image is unidentified, in step S179. Then, the process proceeds to step S175.

The processing elements PE1, PE2, and PE3 decompress the input image, convert the image into bitmap data, and transmit it to the processing element PE4. The processing element PE4 displays the received bitmap image.

In the processing element PE0, the destination to which the data is transmitted is not determined yet at the time when the data is received. As described above, the destination is selected from among the processing elements PE1, PE2, and PE3 in accordance with the processing result in the processing element PE0. Thus, necessary data lines are constructed in advance, and the processing element PE0 can determine and change the data line through which the data is transmitted.

In the distributed processing system according to this embodiment, even while data to be processed is transmitted through the data line DTLN to the processing elements PE, the control unit CU sends control information such as a processing content changing condition through the control line CTLN independent from the data line DTLN without interference with the data processing. At a time when the processing content changing condition is satisfied, the processing element PE can determine or change the processing content such as the destination of output and parameters without an instruction from the control unit CU.

In the prior arts, the processing circuit of a processing element PE has been determined in advance. The processing circuit is determined by the control unit CU. In this embodiment, in contrast, a processing content changing condition is set in advance, and the processing element PE can autonomously change the processing content based on its own determination. Therefore, the system according to this embodiment can be changed with a higher flexibility. Therefore, the problem that the condition cannot be changed during data processing can be eliminated. The process is not blocked by any interrupts. The occurrence of a wasteful process that the data line is changed through the control unit CU is eliminated. Therefore, the process can be executed with improved efficiency.

### Second Embodiment

A distributed processing system according to a second embodiment of the present invention will be described.

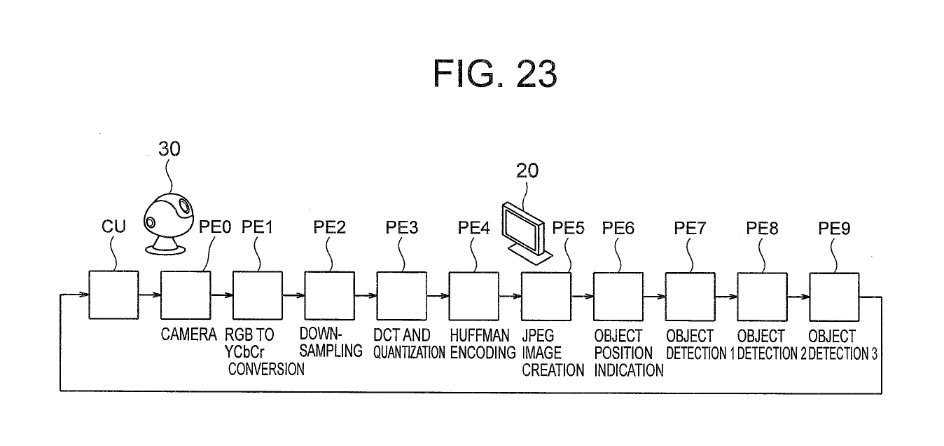

FIG. 23 is a diagram showing the basic configuration of the distributed processing system according to the second embodiment. This distributed processing system is a system for executing image processing.

Processing elements PE0 to PE9 are connected to a control unit CU in a ring topology.

Table 12 shows specifications of the processing elements PE0 to PE9. The processing element PE0 has a camera function. The processing element PE1 has the function of RGB to YCbCr conversion. The processing element PE2 performs downsampling. The processing element PE3 performs DCT (Discrete Cosine Transform) and quantization. The processing element PE4 performs Huffman encoding. The processing element PE5 performs JPEG image creation. The processing element PE6 performs object position drawing. The processing elements PE7, PE8, and PE9 perform object detection.

TABLE 12

| | function of | | |
|---|---|---|---|
| | processing | | |
| ID | element PE | input | output |
| 0 | camera | coordinate of | RGB image |
| | | object position | (moving image) |
| | | (With this | (When a |
| | | input, the | coordinate is |
| | | camera is | input, the |
| | | panned or | camera, panned |
| | | tilted so that | or tilted.) |
| | | the coordinate | |
| | | is positioned | |
| | | at the center of | |
| | | the camera | |
| | | view.) | |
| 1 | RGB to YCbCr | RGB image | YCbCr image |
| | conversion | | |
| 2 | downsampling | YCbCr image | downsampled |
| | | | YCbCr image |
| 3 | DCT and | downsampled | quantized data |
| | quantization | YCbCr image | |
| 4 | Huffman | quantized data | Huffman code |
| | encoding | | |
| 5 | creating JPEG | Huffman code | N.A. |
| | image, | | (No data is |
| | displaying JPEG | | transmitted to |
| | image on monitor | | next processing |
| | | | element PE.) |
| 6 | drawing object | RGB image, | RGB image |
| | position | coordinate of | |
| | indicator | object position | |
| 7, 8, 9 | object | RGB image | coordinates of |
| | detection | | object position |
| | (detection of | | (e.g. X and Y |
| | previously | | coordinates of |
| | registered | | center of |
| | object in input | | object and |
| | image) | | radius) |
| | | | If no object is |
| | | | detected, |
| | | | nothing is |
| | | | output. |

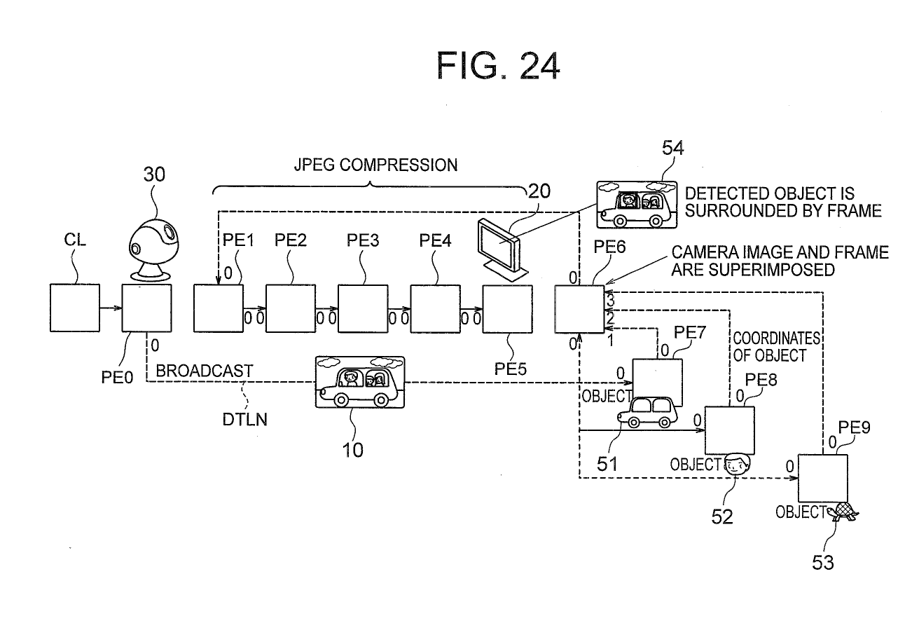

FIG. 24 is a diagram showing an exemplary configuration of a system for detecting an object in a camera image by three parallel processes according to this embodiment. Data line DTLN is constructed in a manner indicated by broken line in FIG. 24.

According to this embodiment, a camera 30 picks up an image. Three processing elements PE7, PE8, and PE9 for object detection superimpose or overlay an indication the presence of a detected object on the picked up image, and compress the resultant image in JPEG format. The monitor 20 displays the result of the processing.

The image picked up by the camera 30 connected to the processing element PE0 is compressed into a JPEG image as it passes through the processing elements PE1 to PE5. The JPEG image is displayed on the monitor 20 connected to the processing element PE5.

The camera image is broadcast to the processing elements PE7 to PE9 before being JPEG-compressed. The processing elements PE7 to PE9 detect whether or not a specific image is found in the input image. If a target object is found in the input image, the processing elements PE7 to PE9 output the coordinates of the object. What is output is, for example, the coordinates (x, y) of the center of the object and the radius of the object, or the coordinates (x, y) of the upper left end of the object and the coordinates (x, y) of the lower right end of the object. A human face 52, a vehicle 51, and/or other objects 53 can be set as the target object as desired.

The processing element PE6 draws an indicator of the position of the object. Specifically, the processing element PE6 draws an indicator the position of the detected object (which is, in this instance, a human face 52) supplied by the processing elements PE7, PE8, and PE9 with lines (e.g. a frame surrounding the object), superimposes it on the image supplied from the camera 30, and transmits, the resultant image to the next processing element PE1.

The JPEG Compression process is divided into processes in the processing elements PE1 to PE5 in accordance with the respective functions provided by the processing elements PE1 to PE5. In the processing element PE5, an JPEG image is created and displayed on the monitor 20.

FIG. 13 shows control commands sent from the control unit CU to the processing elements PE when constructing three parallel data lines for detecting an object. For the sake of simplicity, the control line is not shown in FIG. 13.

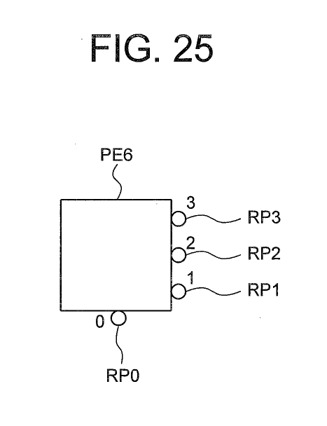

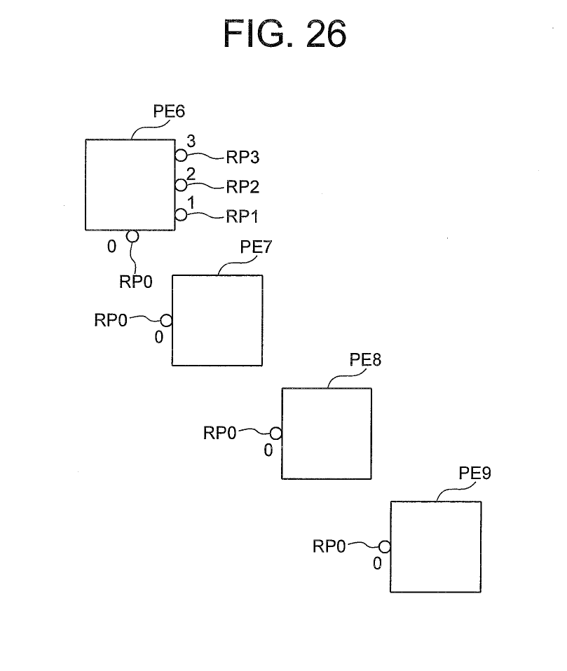

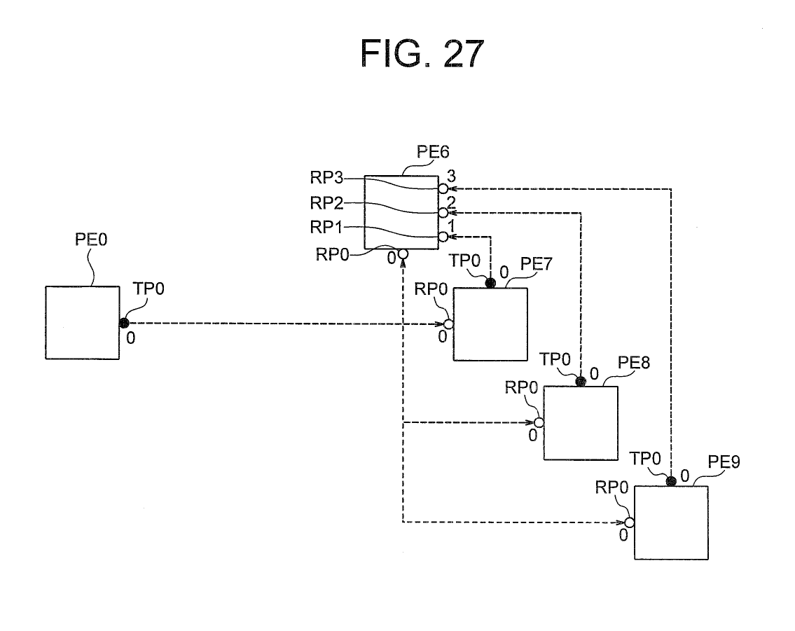

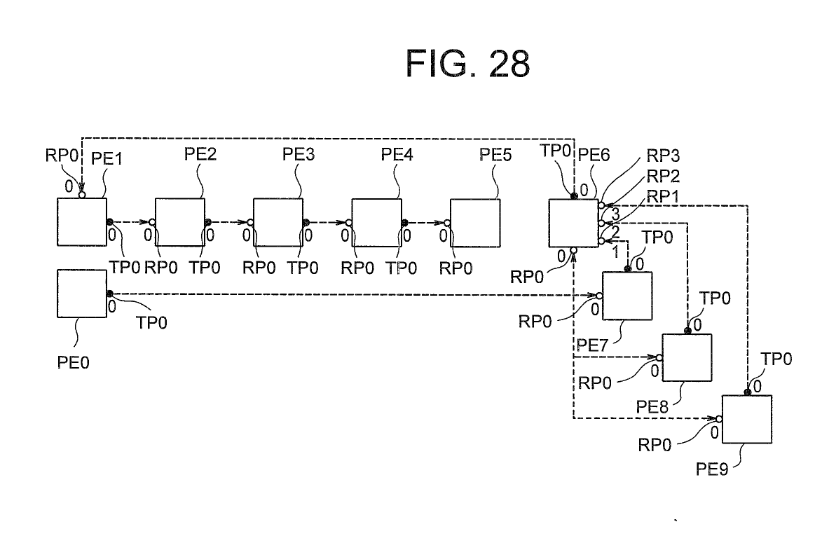

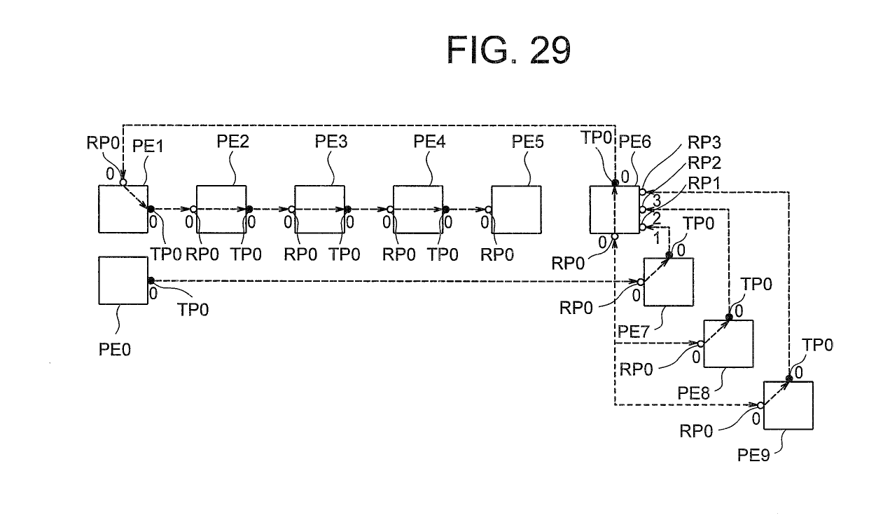

TABLE 13

| | | | | | data line |
|---|---|---|---|---|---|
| | | | | | after |
| number | destination | command | parameter | return value | processing |
| 1 | 6 | receiving | number of | receiving | configuration |
| | | | receiving | port numbers | shown in FIG. 25 |
| | | | ports to be | 0, 1, 2, 3 | |
| | | | created: 4 | | |
| 2 | 7 | receiving | number of | receiving | configuration |
| | | | receiving | port number 0 | shown in FIG. 26 |
| | | | ports to be | | 26 |
| | | | created: 1 | | |
| 3 | 8 | receiving | number of | receiving | configuration |
| | | | receiving | port number 0 | shown in FIG. 26 |
| | | | ports to be | | |
| | | | created: 1 | | |
| 4 | 9 | receiving | number of | receiving | configuration |
| | | | receiving | port number 0 | shown in FIG. 26 |
| | | | ports to be | | |
| | | | created: 1 | | |
| 5 | 0 | transmitting | destination | transmitting | configuration |
| | | | processing | port number 0 | shown in FIG. 27 |
| | | | elements PE: | | |
| | | | 6, 7, 8, 9 | | |
| | | | receiving | | |
| | | | port number: 0 | | |
| | | | broadcast: | | |
| | | | Yes | | |
| 6 | 7 | transmitting | destination | transmitting | configuration |
| | | | processing | port number 0 | shown in FIG. 27 |
| | | | element PE: 6 | | |
| | | | receiving | | |
| | | | port number: 1 | | |
| | | | broadcast: No | | |
| 7 | 8 | transmitting | destination | transmitting | configuration |
| | | | processing | port number 0 | shown in FIG. 27 |
| | | | element PE: 6 | | |
| | | | receiving | | |
| | | | port number: 2 | | |
| | | | broadcast: No | | |
| 8 | 9 | transmitting | destination | transmitting | configuration |
| | | | processing | port number 0 | shown in FIG. 27 |
| | | | element PE: 6 | | |
| | | | receiving | | |
| | | | port number: 3 | | |
| | | | broadcast: No | | |
| 9 | 1 | receiving | number of | receiving | configuration |
| | | | receiving | port number 0 | shown in FIG. 28 |
| | | | ports to be | | |
| | | | created: 1 | | |
| 10 | 2 | receiving | number of | receiving | configuration |
| | | | receiving | port number 0 | shown in FIG. 28 |
| | | | ports to be | | |
| | | | created: 1 | | |
| 11 | 3 | receiving | number of | receiving | configuration |
| | | | receiving | port number 0 | shown in FIG. 28 |
| | | | ports to be | | |
| | | | created: 1 | | |
| 12 | 4 | receiving | number of | receiving | configuration |
| | | | receiving | port number 0 | shown in FIG. 28 |
| | | | ports to be | | |
| | | | created: 1 | | |
| 13 | 5 | receiving | number of | receiving | configuration |
| | | | receiving | port number 0 | shown in FIG. 28 |
| | | | ports to be | | |
| | | | created: 1 | | |
| 14 | 6 | transmitting | destination | transmitting | configuration |
| | | | processing | port number 0 | shown in FIG. 28 |
| | | | element PE: 1 | | |
| | | | receiving | | |
| | | | port number: 0 | | |
| | | | broadcast: No | | |
| 15 | 1 | transmitting | destination | transmitting | configuration |
| | | | processing | port number 0 | shown in FIG. 28 |
| | | | element PE: 2 | | |
| | | | receiving | | |
| | | | port number: 0 | | |
| | | | broadcast: No | | |
| 16 | 2 | transmitting | destination | transmitting | configuration |
| | | | processing | port number 0 | shown in FIG. 28 |
| | | | element PE: 3 | | |
| | | | receiving | | |
| | | | port number: 0 | | |
| | | | broadcast: No | | |
| 17 | 3 | transmitting | destination | transmitting | configuration |
| | | | processing | port number 0 | shown in FIG. 28 |
| | | | element PE: 4 | | |
| | | | receiving | | |
| | | | port number: 0 | | |
| | | | broadcast: No | | |
| 18 | 4 | transmitting | destination | transmitting | configuration |
| | | | processing | port number 0 | shown in FIG. 28 |
| | | | element PE: 5 | | |
| | | | receiving | | |
| | | | port number: 0 | | |
| | | | broadcast: No | | |
| 19 | 7 | association | receiving | success | configuration |
| | | | port number: 0 | | shown in FIG. 29 |
| | | | transmitting | | |
| | | | port number: 0 | | |
| 20 | 8 | association | receiving | success | configuration |
| | | | port number: 0 | | shown in FIG. 29 |
| | | | transmitting | | |
| | | | port number: 0 | | |
| 21 | 9 | association | receiving | success | configuration |
| | | | port number: 0 | | shown in FIG. 29 |
| | | | transmitting | | |
| | | | port number: 0 | | |
| 22 | 6 | association | receiving | success | configuration |
| | | | port number: 0 | | shown in FIG. 29 |
| | | | transmitting | | |
| | | | port number: 0 | | |
| 23 | 1 | association | receiving | success | configuration |
| | | | port number: 0 | | shown in FIG. 29 |
| | | | transmitting | | |
| | | | port number: 0 | | |
| 24 | 2 | association | receiving | success | configuration |
| | | | port number: 0 | | shown in FIG. 29 |
| | | | transmitting | | |
| | | | port number: 0 | | |
| 25 | 3 | association | receiving | success | configuration |
| | | | port number: 0 | | shown in FIG. 29 |
| | | | transmitting | | |
| | | | port number: 0 | | |
| 26 | 4 | association | receiving | success | configuration |
| | | | port number: 0 | | shown in FIG. 29 |
| | | | transmitting | | |
| | | | port number: 0 | | |

FIG. 25 is a diagram showing the configuration after the execution of the command 1 shown in Table 13. The control unit CU sends the receiving port creation command 1 to the processing element PE6. Then, four receiving ports RP0, RP1, RP2, and RP3 are created in the processing element PE6 according to the command 1.

FIG. 26 is a diagram showing the configuration after the execution of the commands 2, 3, and 4 shown in Table 13. The control unit CU sends the receiving port creation commands 2, 3, and 4 to the processing elements PE7, PE8, and PE9 respectively. Then, a receiving port RP0 is created in each of the processing elements PE7, PE8, and PE9 according to the commands 2, 3, and 4.

FIG. 27 is a diagram showing the configuration after the execution of the commands 5, 6, 7, and 8 shown in Table 13. The control unit CU sends the transmitting port creation commands 5, 6, 7, and 8 to the processing elements PE0, PE7, PE8, and PE9 respectively. Then, a transmitting port TP0 is created in each of the processing elements PE0, PE7, PE8, and PE9 according to the commands 5, 6, 7, and 8.

FIG. 28 is a diagram showing the configuration after the execution of the commands 9 to 18 shown in Table 13. The control unit CU sends the receiving port creation commands 9 to 13 to the processing elements PE1, PE2, PE3, PE4, and PE5 respectively. Then, a receiving port RP0 is created in each of the processing elements PE1, PE2, PE3, PE4, and PE5 according to the commands 9 to 13.

The control unit CU sends the transmitting port creation commands 14 to 18 to the processing elements PE6, PE1, PE2, PE3, and PE4 respectively. Then, a transmitting port TP0 is created in each of the processing elements PE6, PE1, PE2, PE3, and PE4 according to the commands 14 to 18.

FIG. 29 is a diagram showing the configuration after the execution of the commands 19 to 26 shown in Table 13. The control unit CU sends the transmitting port-receiving port association commands 19 to 26 to the processing elements PE7, PE8, PE9, PE6, PE1, PE2, PE3 and PE4 respectively. Then, the receiving port RP0 is associated with the transmitting port TP0 in each of the processing elements PE7, PE8, PE9, PE6, PE1, PE2, PE3 and PE4 according to the commands 19 to 26.

In this distributed processing system, the camera 30 transmits image data through the data line indicated by broken line, and the image with the object detection result superimposed thereon is output on the monitor 20 of the processing element PE5.

In the following, an example of a dynamic changing of the data line will be described.

In the first embodiment, the processing elements PE determine the destination of transmission based on the processing result. On the other hand, in the following example, the control unit CU instructs the switching of the data line.

In the system having the data line constructed by the above procedure, a description will be made of a case in which a data line through which an output of the processing element PE9 that detects an object, for example information on coordinates of the detected object, is to be transmitted to the PE0 functioning as the camera 30 is created while data flows, and the data line is switched.

Table 14 shows the commands sent from the control unit CU to the processing elements PE when dynamically changing the data line.

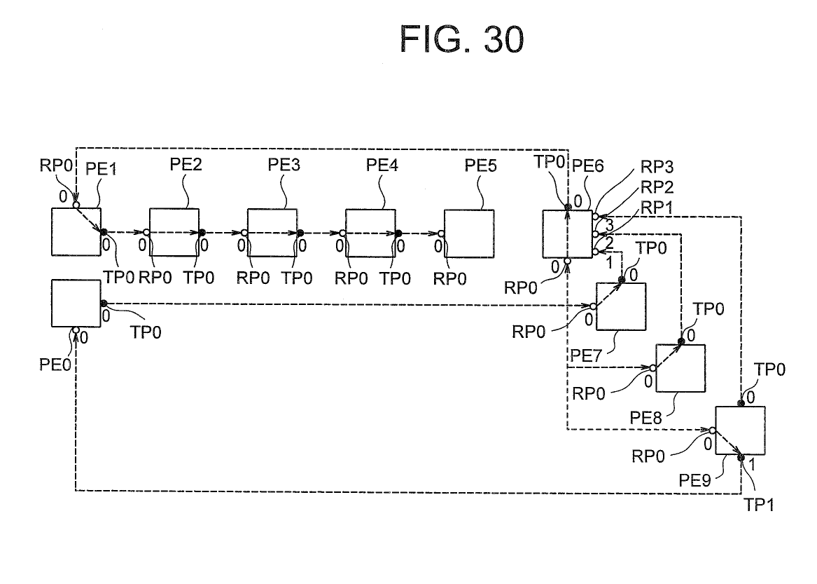

TABLE 14

| | | | | | data line |
|---|---|---|---|---|---|
| | | | | | after |
| number | destination | command | parameter | return value | processing |
| 27 | 0 | receiving | number of | receiving | configuration |
| | | | receiving | port number 0 | shown in FIG. 30 |
| | | | ports to be | | |
| | | | created: 1 | | |
| 28 | 9 | transmitting | destination | transmitting | configuration |
| | | | processing | port number 1 | shown in FIG. 30 |
| | | | element PE: 0 | | |
| | | | receiving | | |
| | | | port number: 0 | | |
| | | | broadcast: | | |
| | | | No | | |
| 29 | 0 | configuration | receiving | success | configuration |
| | | | coordinate | | shown in FIG. 30 |
| | | | data at | | |
| | | | receiving | | |
| | | | port number 0 | | |
| 30 | 9 | association | receiving | success | configuration |
| | | | port number: 0 | | shown in FIG. 30 |
| | | | transmitting | | |
| | | | port number: 1 | | |

FIG. 30 is a diagram showing the configuration after the execution of the commands 27 to 30 shown in Table 14. The control unit CU sends the receiving port creation command 27 to the processing element PE0. Then, a receiving port RP0 is created in the processing element PE0 according to the command 27.

The control unit CU sends the transmitting port creation command 28 to the processing element PE9. Then, a transmitting port TP1 is created in the processing element PE9 according to the command 28.

The control unit CU sends the processing element configuration command 29 to the processing element PE0. Then, the processing element PE0 is configured to receive coordinate data through the receiving port RP0, according to the command 29.

As a result, the processing element PE9 and the processing element PE0 are connected with each other. The output or the result of processing of the data input to the processing element PE9 is transmitted to the processing element PE0 having the camera function. The camera 30 has the function of panning and tilting so that the center of the received coordinate data is moved to the center of the image.

The camera 30 does not receive any input before the data line is constructed. Therefore, the camera 30 performs no operation other than transmitting an image. After the data line is dynamically changed, the coordinate data is input to the camera 30 through the data line. As a result, the camera 30 starts to pan and/or tilt based on the input coordinate information.

In some cases, the timing of switching the data line in the processing element PE9 may be desired to be set not at the time of the arrival of the'control information but at a time after the arrival of designated data. When this is the case, sequential numbers may be assigned to the data files, and the data line may be switched after the arrival of a specific data file.

The dynamic changing of the data line as described above allows the execution of the process without an interruption of the data flow, even when a new data line is created during the data processing.

### First Modification of Second Embodiment

In the following, an example of dynamic changing of processing elements PE to be used will be described.

There will be described a procedure of replacing a processing element PE with an ID of 2 providing a downsampling function with another processing element PE having a downsampling function during data processing.

A new processing element PE10, to which an ID of 10 is assigned, is newly prepared as a processing element that executes downsampling.

The control unit CU sends a processing element information obtaining command to the processing element PE10. Thus, the control unit CU obtains information on the basic performance of the processing element PE10. Here, the downsampling performance (number of times/sec) and rated power consumption will be discussed as the basic performance of the processing element PE10.

The control unit CU makes a comparison between the processing element PE for executing downsampling presently in use and the new processing element PE10. The control unit CU makes the comparison based on a criterion such as “higher performance” or “lower power consumption”.

If the control unit CU determines that a higher advantage can be provided by the appearance of the new processing element PE10 having the downsampling function, the control unit creates a new data line. This changes the flow of the data.

Table 15 shows the content of the command sent from the control unit CU to the processing elements PE when replacing the processing element PE for executing the downsampling. In Table 15, “transmission deletion” refers to a transmitting port deletion command, and “reception deletion” refers to a receiving port deletion command.

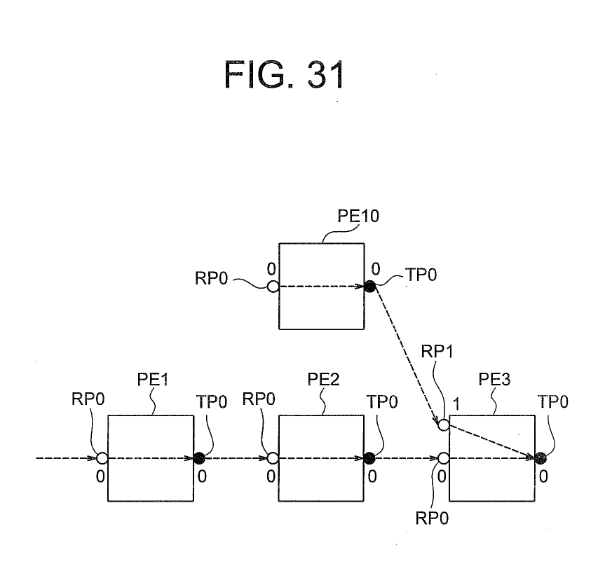

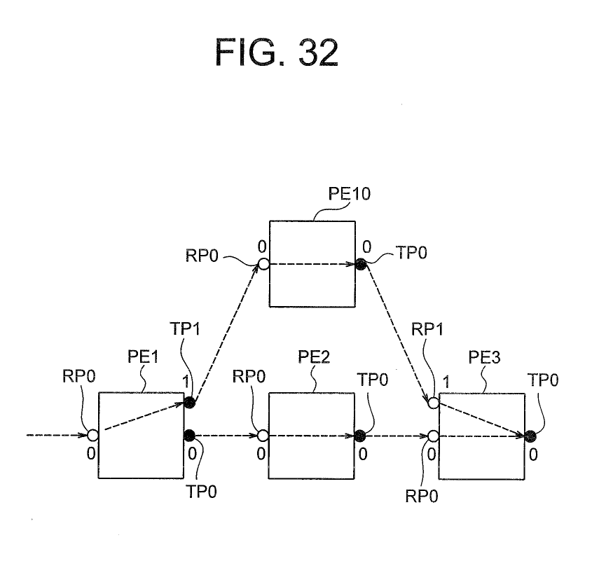

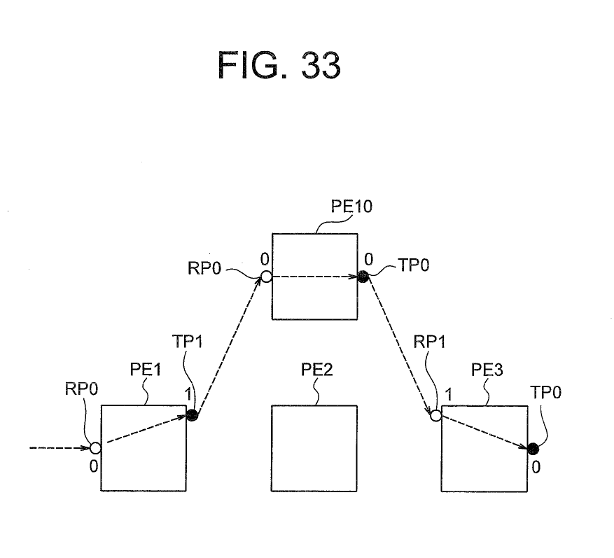

TABLE 15

| | | | | | data line |
|---|---|---|---|---|---|
| | | | | | after |
| number | destination | command | parameter | return value | processing |
| 31 | 3 | receiving | number of | receiving | configuration |
| | | | receiving | port number 1 | shown in FIG. 31 |
| | | | ports to be | | |
| | | | created: 1 | | |
| 32 | 3 | association | receiving | success | configuration |
| | | | port number: 1 | | shown in FIG. 31 |
| | | | transmitting | | |
| | | | port number: 0 | | |
| 33 | 10 | receiving | number of | receiving | configuration |
| | | | receiving | port number 0 | shown in FIG. 31 |
| | | | ports to be | | |
| | | | created: 1 | | |
| 34 | 10 | transmitting | destination | transmitting | configuration |
| | | | processing | port number 0 | shown in FIG. 31 |
| | | | element PE: 3 | | |
| | | | receiving | | |
| | | | port number: 1 | | |
| | | | broadcast: No | | |
| 35 | 10 | association | receiving | success | configuration |
| | | | port number: 0 | | shown in FIG. 31 |
| | | | transmitting | | |
| | | | port number: 0 | | |
| 36 | 1 | transmitting | destination | transmitting | configuration |
| | | | processing | port number 1 | shown in FIG. 32 |
| | | | element PE: | | |
| | | | 10 | | |
| | | | receiving | | |
| | | | port number: 0 | | |
| | | | broadcast: No | | |
| 37 | 1 | association | receiving | success | configuration |
| | | | port number: 0 | | shown in FIG. 32 |
| | | | transmitting | | |
| | | | port number: 1 | | |
| 38 | 3 | reception | receiving | success | configuration |
| | | deletion | port number: 0 | | shown in FIG. 33 |
| 39 | 2 | transmission | transmitting | success | configuration |
| | | deletion | port number: 0 | | shown in FIG. 33 |
| 40 | 2 | reception | receiving | success | configuration |
| | | deletion | port number: 0 | | shown in FIG. 33 |
| 41 | 1 | transmission | transmitting | success | configuration |
| | | deletion | port number: 0 | | shown in FIG. 33 |

FIG. 31 is a diagram showing a portion of the system after the execution of the commands 31 to 35 in Table 15, where only the processing elements PE for which a change has been made are shown. The control unit CU sends the receiving port creation command 31 to the processing element PE3. Then, a receiving port RP1 is created in the processing element PE3 according to the command 31.

The control unit CU sends the transmitting port-receiving port association command 32 to the processing element PE3. Then, the receiving port RP1 is associated with the transmitting port TP0 in the processing element PE3 according to the command 32.

The control unit CU sends the receiving port creation command 33 to the processing element PE10. Then, a receiving port RP0 is created in the processing element PE10 according to the command 33.

The control unit CU sends the transmitting port creation command 34 to the processing element PE10. Then, a transmitting port TP0 is created in the processing element PE10 according to the command 34.

The control unit CU sends the transmitting port-receiving port association command 35 to the processing element PE10. Then, the receiving port RP0 is associated with the transmitting port TP0 in the processing element PE10 according to the command 35.

FIG. 32 is a diagram showing a portion of the system after the execution of the commands 36 and 37 in Table 15, where only the processing elements PE for which a change has been made are shown.

The control unit CU sends the transmitting port creation command 36 to the processing element PE1. Then, a transmitting port TP1 is created in the processing element PE1 according to the command 36.

The control unit CU sends the transmitting port-receiving port association command 37 to the processing element PE1. Then, the receiving port RP0 is associated with the transmitting port TP1 in the processing element PE1 according to the command 37.

FIG. 33 is a diagram showing a portion of the system after the execution of the commands 38 to 41 in Table 15, where only the processing elements PE for which a change has been made are shown.

The control unit CU sends the receiving port deletion command 38 to the processing element PE3. Then, the receiving port RP0 in the processing element PE3 is deleted according to the command 38.

The control unit CU sends the transmitting port deletion command 39 to the processing element PE2. Then, the transmitting port TP0 in the processing element PE2 is deleted according to the command 39.

The control unit CU sends the receiving port deletion command 40 to the processing element PE2. Then, the receiving port RP0 in the processing element PE2 is deleted according to the command 40.

The control unit CU sends the transmitting port deletion command 41 to the processing element PE1. Then, the transmitting port TP0 in the processing element PE1 is deleted according to the command 41.

Thus, the data line running from the processing element PE1 to the processing element PE10 and then to the processing element PE3 is constructed. Finally, the association between the transmitting port and the receiving port in the processing element PE1 is changed from the association between the receiving port number 0 and the transmitting port number 0 to the association between the receiving port number 0 and the transmitting port number 1. Thus, the data line running from the processing element PE1 to the processing element PE10 and then to the processing element PE3 is established.

Subsequently, the data lines connected to the processing element PE2 are deleted, because no data passes through the processing element PE2. The processing element PE2 may be used in another process when the process is started.

The above-described replacing process is advantageous in cases where a processing element PE having higher processing speed than the firstly used processing element PE for downsampling is prepared later, or in cases where the processing by the processing element PE2 is replaced by processing by a new element PE without interrupting the processing when the processing element PE2 goes out of order.

The control unit CU performs processing element configuration for the processing element PE1 when two data lines for transmitting data from the processing element PE1 are established while leaving the data line running from the processing element PE1 to the processing element PE2 and then to the processing element PE3. In this case, the processing element PE1 may transfer data alternately to the transmitting port with a port number of 0 and the transmitting port with a port number of 1 in the processing element PE1 on its own determination, thereby distributing the process.

In the above-described state in which two processing elements PE for downsampling are connected next to the processing element PE1, the process is normally executed in the processing element PE1, the processing element PE2, and the processing element PE3 in the mentioned order.

The control unit CU generates a processing element information obtaining command. The control unit CU sends the processing element information obtaining command to the processing element PE2 and the processing element PE10 to check them. If a response is returned to the control unit CU, the control unit CU determines that the processing element PE is operating normally.

On the other hand, if no response is returned from the processing element PE2, the control unit CU determines that the processing element PE2 is out of order. Consequently, the control unit CU sends a transmitting port-receiving port association command to the processing element PE1, and the processing element PE1 changes the destination of the receiving port with a port number of 0 to the transmitting port with a port number of 1.

Thus, the configuration can be changed to use the processing element PE10. Therefore, in this modification of the second embodiment, a defective section in the data flow in the distributed processing system can be detected, and the control unit CU can change the data flow. In this way, the system can deal with a failure flexibly.

As described above, even when a new data line is created during data processing, the process can be executed without interrupting the flow of data. Furthermore, processing by a certain processing element can be replaced by processing by another more suitable processing element PE.

In the following, a second modification of the second embodiment will be described. In this modification, the processing elements PE are dynamically parallelized.

There will be described a case in which the number of processing elements PE for downsampling is 1 when the process starts, and another processing element PE for downsampling is added during the process to execute downsampling in two parallel processes. For example, one of the processing elements for downsampling may process the upper half of the area of an image, and the other processing element for downsampling may process the lower half of the area of the image. Then, the processing speed is improved by performing distributed processing with the two processing elements.

In the following description, it is assumed that the newly added processing element PE for downsampling has an ID of 11.

Table 16 shows the content of the commands sent from the control unit CU to the processing elements PE when the downsampling process is changed to be executed by two processing elements PE in parallel.

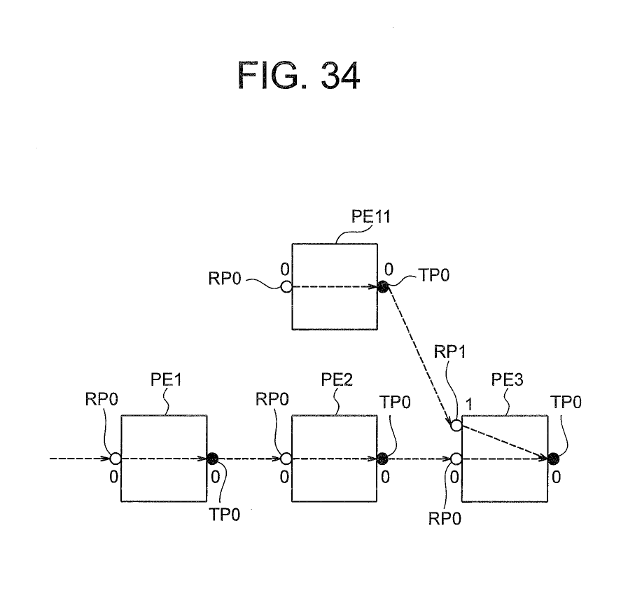

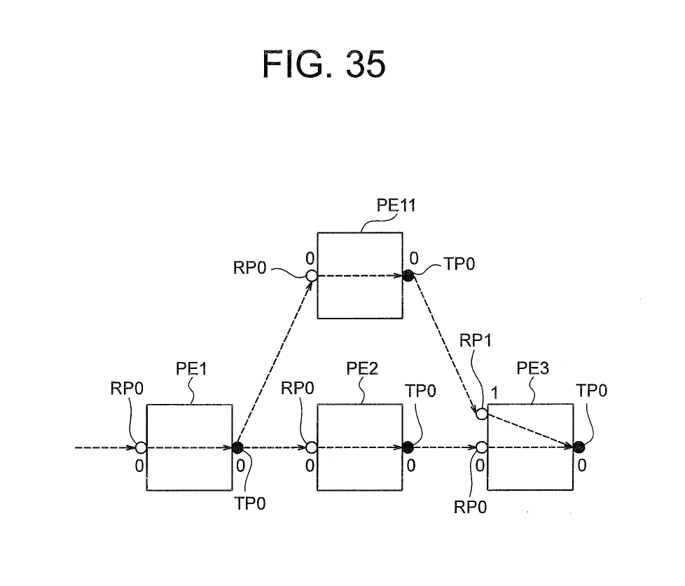

TABLE 16

| | | | | | data line |
|---|---|---|---|---|---|
| | | | | | after |
| number | destination | command | parameter | return value | processing |
| 42 | 3 | receiving | number of | receiving port | configuration |
| | | | receiving | number 1 | shown in FIG. 34 |
| | | | ports to be | | |
| | | | created: 1 | | |
| 43 | 3 | association | receiving | success | configuration |
| | | | port number: 1 | | shown in FIG. 34 |
| | | | transmitting | | |
| | | | port number: 0 | | |
| 44 | 11 | receiving | number of | receiving port | configuration |
| | | | receiving | number 0 | shown in FIG. 34 |
| | | | ports to be | | |
| | | | created: 1 | | |
| 45 | 11 | transmitting | destination | transmitting | configuration |
| | | | processing | port number 0 | shown in FIG. 34 |
| | | | element PE: 3 | | |
| | | | receiving | | |
| | | | port number: 1 | | |
| | | | broadcast: No | | |
| 46 | 11 | association | receiving | success | configuration |
| | | | port number: 0 | | shown in FIG. 34 |
| | | | transmitting | | |
| | | | port number: 0 | | |
| 47 | 3 | configuration | data | success | configuration |
| | | | integration | | shown in FIG. 34 |
| 48 | 11 | configuration | processing | success | configuration |
| | | | area setting | | shown in FIG. 34 |
| 49 | 2 | configuration | processing | success | configuration |
| | | | area setting | | shown in FIG. 34 |
| 50 | 1 | transmitting | destination | success | configuration |
| | | | processing | | shown in FIG. 35 |
| | | | element PE: | | |
| | | | 2, 11 | | |
| | | | receiving | | |
| | | | port number: | | |
| | | | 0, 0 | | |
| | | | broadcast: | | |
| | | | Yes | | |

FIG. 34 is a diagram showing a portion of the system after the execution of the commands 42 to 49 in Table 16, where only the processing elements PE for which a change has been made are shown.

The control unit CU sends the receiving port creation command 42 to the processing element PE3. Then, a receiving port RP1 is created in the processing element PE3 according to the command 42.

The control unit CU sends the transmitting port-receiving port association command 43 to the processing element PE3. Then, the receiving port RP1 and the transmitting port TP0 are associated with each other in the processing element PE3 according to the command 43.

The control unit CU sends the receiving port creation command 44 to the processing element PE11. Then, a receiving port RP0 is created in the processing element PE11 according to the command 44.

The control unit CU sends the transmitting port creation command 45 to the processing element PE11. Then, a transmitting port TP0 is created in the processing element PE11 according to the command 45.

The control unit CU sends the transmitting port-receiving port association command 46 to the processing element PE11. Then, the receiving port RP0 and the transmitting port TP0 are associated with each other in the processing element PE11 according to the command 46.

The control unit CU sends the processing element configuration command 47 to the processing element PE3. Then, the receiving port RP0 (receiving port number 0) and the receiving port RP1 (receiving port number 1) are integrated in the processing element PE3 according to the command 47.

The control unit CU sends the processing element configuration command 48 to the processing element PE11. Then, the area of the image for which downsampling is to be performed is set in the processing element PE11 according to the command 48.

The control unit CU sends the processing element configuration command 49 to the processing element PE2. Then, the area of the image for which downsampling is to be performed is set in the processing element PE2 according to the command 49.

The control unit CU sends the transmitting port creation command 50 to the processing element PE1. Then, a transmitting port TP0 is created in the processing element PE1 according to the command 50.

With the above described procedure, a data line running from the second processing element PE11 having an ID of 11 for downsampling to the receiving port RP1 (receiving port number 1) of the processing element PE3 for DCT and quantization is created, and the processing element PE11 is configured to be able to receive, at its receiving port RP0 (receiving port number 0), data transmission from the processing element PE1 having an ID of 1.

With the configuration described heretofore, downsampling can be executed in parallel by transmitting data from the processing element PE1 to the processing element PE11 by broadcast. At this stage, the other processing elements PE need to change the processing they are executing. Therefore, configuration of the processing elements needs to be performed in advance.

The control unit CU sends processing element configuration commands, thereby:

integrating the receiving port RP0 (receiving port number 0) and the receiving port RP1 (receiving port number 1) in the processing element PE3;
configuring the processing element PE11 to downsample the upper half of the picture area of the received data; and
configuring the processing element PE2 to downsample the lower half of the picture area of the received data.

To determine the timing of starting the dynamic parallelization of processing elements PE, an incremented numerical value is assigned to image data, and this numerical value is incremented every time the image data is received by the data receiving section of a processing element PE. The control unit CU monitors the incremented numerical value and starts the parallel processing when the incremented numerical value reaches a specified value, thereby achieving synchronization of the processing elements PE.

FIG. 35 is a diagram showing a portion of the system after the execution of the command 50 in Table 16, where only the processing elements PE for which a change has been made are shown.

In the processing element PE1 having an ID of 1, the destination of transmission from the existing transmitting port TP0 with a transmitting port number of 0 is changed so that the transmission is broadcast to the processing elements PE2 and PE11. The area of the image may be divided into the upper half area and the lower half area, and image data of the respective half areas may respectively be unicast to the processing elements PE2 and PE11 instead of broadcast.

As descried above, in this modification, the data line for processing can be changed even while data is flowing. Data may be transmitted in a single route at first, and when a new processing element PE becomes available, the data line can be changed without interrupting the data flow. This allows the parallelization of the system, enabling an increase the processing speed.

In the following, a distributed processing system according to a third modification of the second embodiment will be described.

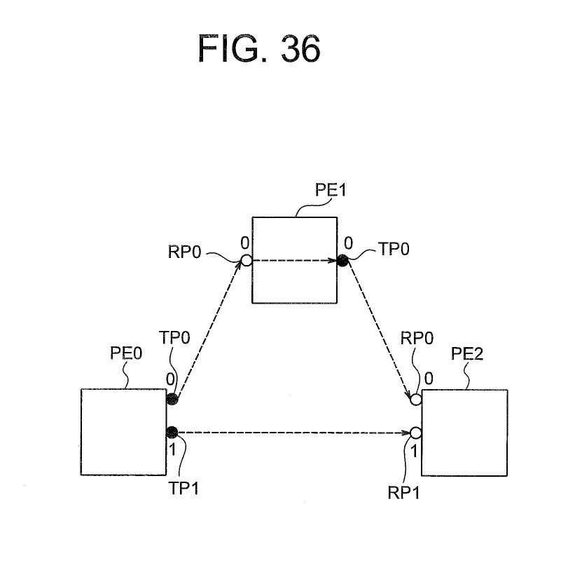

FIG. 36 is a diagram illustrating a case in which a processing with a large load is divided into pre-processing and main processing and a bypass data line is created according to the third modification of the second embodiment.

In the data line shown in FIG. 36, image data is input to the processing element PE0, which is used to determine whether or not a human face is found in the input image. If it is determined by the processing element PE0 that a human face is found in the image, the processing element PE0 transmits the image to the processing element PE1. The processing element PE1 provides more detailed analysis of the image, for example, identifies a specific person by characteristic measurements of the face.

The processing element PE1 transmits the image data to the processing element PE2 together with the personal information. The processing element PE0 executes, as pre-processing, rough processing such as a determination as to whether or not a face is found in the image. On the other hand, the processing element PE1 is used to execute time-consuming main processing such as an identification of a specific person, if necessary. If not necessary, the processing element PE1 transmits the image data to the next processing element PE2.

Thus, heavy processing or processing with a large load is divided into pre-processing and main processing. If it is determined by the processing element PE for the pre-processing that the main processing is not needed, the main processing is skipped. This enhances the efficiency the processing.

In the following, a distributed processing system according to a third embodiment will be described. In this embodiment, the operation of a processing element PE is dynamically changed.

The configuration of the distributed processing system according to the third embodiment is the same as the configuration in the second embodiment shown in FIG. 23, and descriptions of similar components and functions will not be made. In the case described in the following as the third embodiment, control information is sent to a processing element PE3 for quantization in an object recognition process, and the operation of the processing element PE3 is dynamically changed.

Quantization is executed in the processing element PE3 for DCT and quantization having an ID of 3. The processing element PE3 for DCT and quantization has a quantization table in it. It is assumed that the content of the quantization table can be changed by control information sent from the control unit CU.

A quantization table is contained in the control information CTINF to be sent to the processing element PE3. The control information CTINF is sent to the processing element PE3 for DCT and quantization, whereby the quantization table in the processing element PE3 is replaced by the quantization table contained in the control information CTINF.

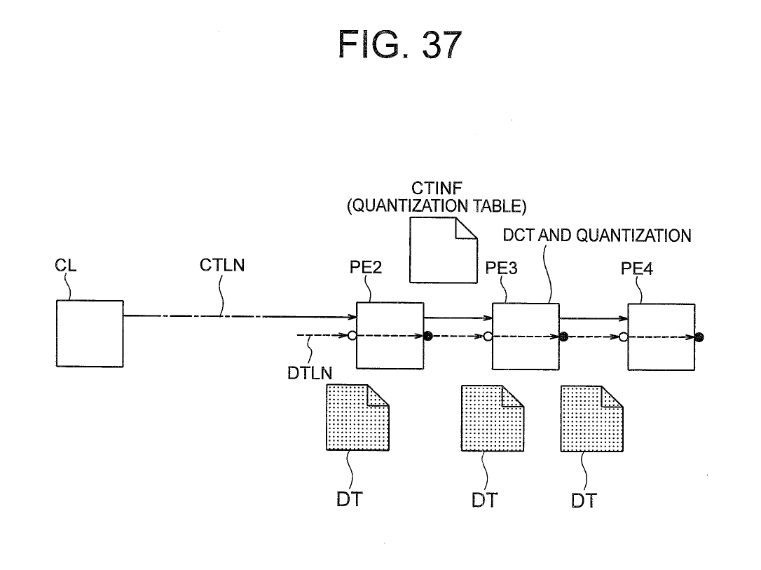

FIG. 37 is a diagram illustrating a process in which a quantization table is sent, as control information CTINF, from the control unit CU to the processing element PE3 for DCT and quantization in the third embodiment.

The control line is not in use even while data is ceaselessly transmitted to the processing element PE3. Therefore, the control information CTINF can be delivered to the specific processing element PE3 efficiently.

Therefore, the control unit CU can quickly change the quantization table even in situations in which real time processing is required, such as in processing a live image. This consequently enables, for example, adjustment of image quality.

The parameter sent from the control unit CU to the processing element PE for DCT and quantization may include only a coefficient by which the values in the quantization table are to be multiplied or divided, instead of an entire quantization table.

In the following, an exemplary case in which the control unit CU sends a computation parameter changing condition to a processing element PE, and the processing element PE changes the computation parameter based on the condition will be discussed.

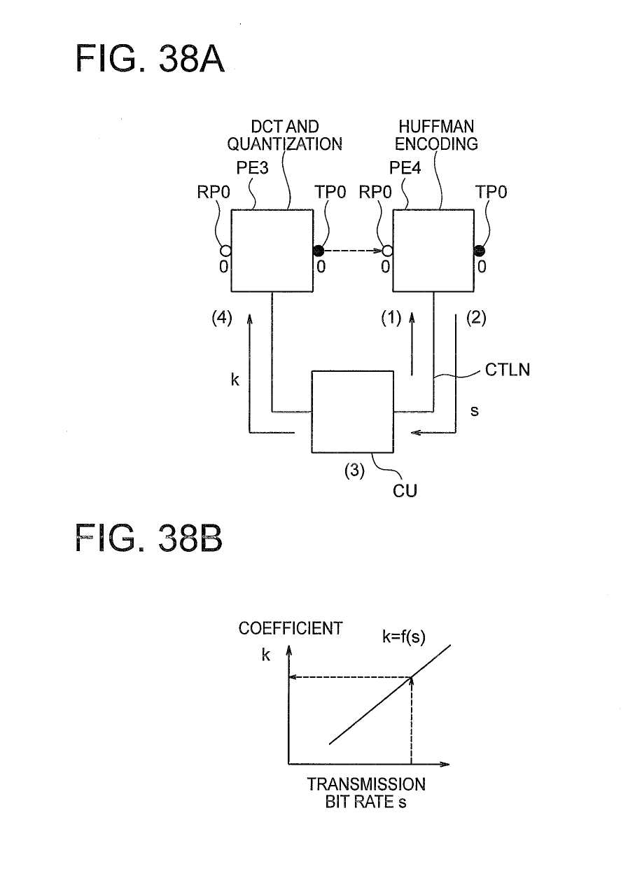

FIG. 38A is a diagram illustrating a case in which a computation parameter of a processing element PE is changed through the control unit CU based on control information from the processing element PE.

FIG. 38B is a diagram showing the relationship between the transmission bit rate and a coefficient k.

The control unit CU sends a processing element information obtaining command to a processing element PE4 for Huffman encoding having an ID of 4 in procedure (1) in FIG. 38A.

The control unit CU obtains the value of the transmission bit rate of Huffman encoding in procedure (2) in FIG. 38A. The processing element PE4 may obtain the byte size output at a time instead of the value of the transmission bit rate.

As the values in the quantization table are increased, the compression ratio increases, and the output of Huffman encoding decreases accordingly. As the values in the quantization table are decreased, the output of Huffman encoding increases.

The control unit CU calculates, in procedure (3) in FIG. 38A, a coefficient by which the quantization table is to be multiplied based on the value of the transmission bit rate of Huffman encoding. The image quality is determined by this coefficient. As the value of the coefficient increases, the values in the quantization table increase, the compression ratio increases, and the output of Huffman encoding decreases.

For example, the coefficient k is calculated as a function of the transmission bit rate s, namely the coefficient k is defined as k=f(s).

The control unit CU sends the calculated coefficient as a processing element configuration command to the processing element PE3 for DCT and quantization in procedure (4) in FIG. 38A. Then, the processing element PE3 for DCT and quantization will use updated quantization table values in the next quantization process.

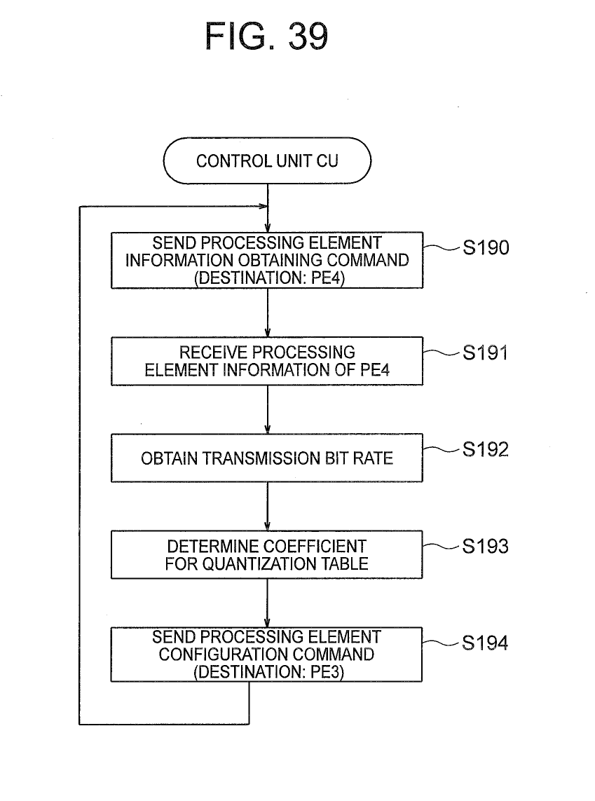

FIG. 39 is a flow chart of the above-described process in which a computation parameter changing condition is sent from the control unit CU to a processing element PE to change a parameter.

In step S190, the control unit CU sends a processing element information obtaining command to the processing element PE4. Step S190 corresponds to procedure (1) in FIG. 38A.

In step S191, the control unit CU receives the processing element information of the processing element PE4. Step S191 corresponds to procedure (2) in FIG. 38A.

In step S192, the control unit CU obtains the value of the transmission bit rate of Huffman encoding. Step S192 corresponds to procedure (3) in FIG. 38A

In step S193, the control unit CU determines the coefficient k for the quantization table as described above. The control unit CU may be adapted to generate and/or select the coefficient k for the quantization table. Step S193 corresponds to procedure (3) in FIG. 38A.

In step S194, the control unit CU sends the calculated coefficient as a processing element configuration command to the processing element PE3 for DCT and quantization. Step S194 corresponds to procedure (4) in FIG. 38A.

After the DCT process and before the quantization process, the data processing section of the processing element PE3 asks the processing content changing section about the values in the quantization table in order to determine the quantization table. The processing content changing section determines the quantization table based on the condition set by the control unit CU and sends it to the data processing section. The data processing section executes quantization with the updated quantization table.

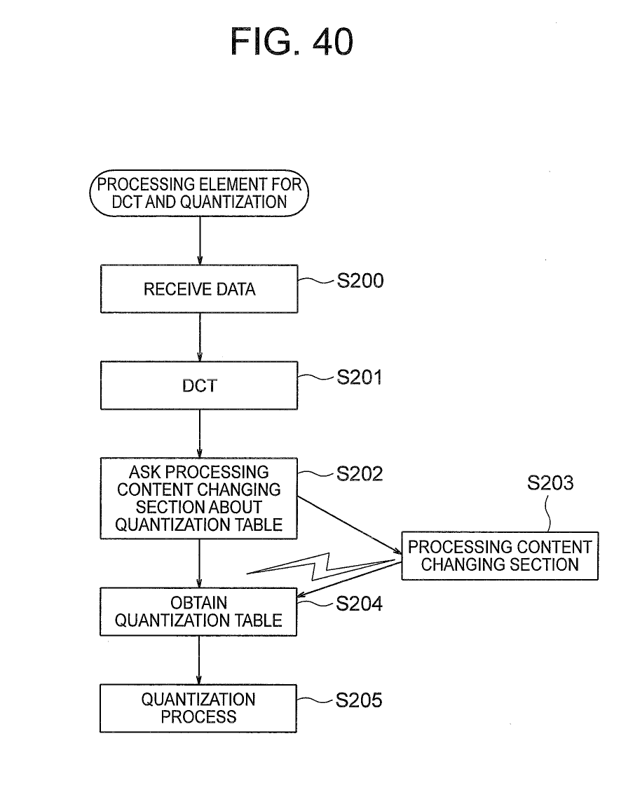

FIG. 40 is a flow chart of a data processing procedure in the above-described processing element PE3 for DCT and quantization.

In step S200, the processing element PE3 receives data.

In step S201, the processing element PE3 executes DCT.

In step S202, the data processing section of the processing element PE3 asks the processing content changing section about the values in the quantization table in order to determine the quantization table.

In step S203, the processing content changing section provides the quantization table thus determined to the data processing section.

In step S204, the data processing section of the processing element PE3 receives the updated quantization table.

In step S205, the data processing section of the processing element PE3 executes quantization with the updated quantization table.

The control unit CU refers to the output of Huffman encoding affected by the change in the quantization table in the processing element PE3. The control unit CU further adjusts the quantization table taking into account the effect of the change in the quantization table. The control unit CU repeatedly executes the adjustment. Thus, the quality of the JPEG compressed image can be maintained at a constant level. Alternatively, the throughput can be maintained constant.

In the above description, an appropriate coefficient by which the quantization table is to be multiplied is calculated by the control unit. However, the calculation of the coefficient is not limited to be executed by the control unit CU, but the processing element PE3 itself may be adapted to calculate the coefficient. The processing element PE3 for DCT and quantization can calculate the coefficient if it holds the content of the formula k=f(s).

The control unit CU sends the obtained value of the transmission bit rate of Huffman encoding to the processing element PE3 for DCT and quantization. Thus, the processing element PE3 itself can calculate the coefficient. This allows the processing element PE to change the processing content in accordance with the processing condition, and more flexible data flow can be achieved.

In the following, an exemplary case in which the content of processing is changed independently from the control unit CU will be described. In this case, a feedback from one processing element to another is performed.

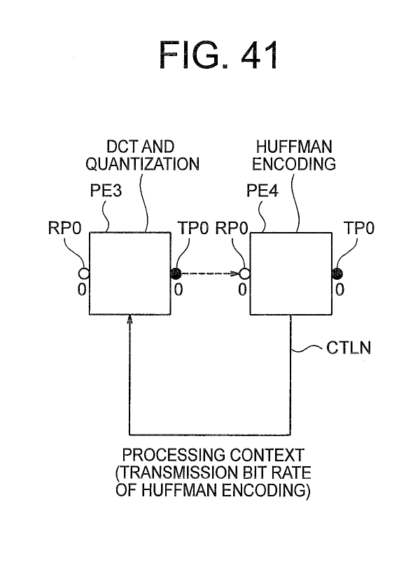

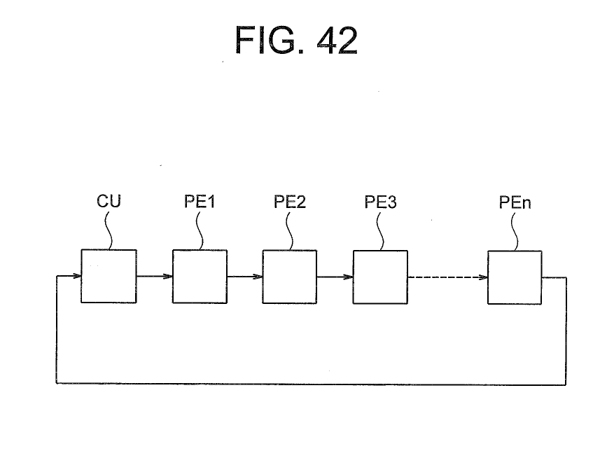

FIG. 41 is a diagram illustrating a configuration in which control information is sent between processing elements PE, and the computation parameter is changed independently from the control unit CU.

The output of the processing element PE4 for Huffman encoding and the processing element PE3 for DCT and quantization are connected to each other by a control line CTLN.

The control unit CU configures the processing element PE4 for Huffman encoding, by a processing element configuration command, in such a way that the processing element PE4 sends the value of the transmission bit rate to the processing element PE3 through the control line CTLN.

The control unit CU configures the processing element PE3 for DCT and quantization, by a processing element configuration command, in such a way that the processing element PE3 records control information such as the byte size of data after encoding sent from the processing element PE4 for Huffman encoding, in the processing content changing section.

The control unit CU also configures the processing element PE3 for DCT and quantization, by a processing element configuration command, in such a way that the processing element PE3 calculates a coefficient for the quantization table using the byte size of data after encoding as a processing context.

Thus, the processing element PE3 for DCT and quantization can receive, through the control line CTLN, the value of the transmission bit rate in the transmission of the result of Huffman encoding. In other words, the processing element PE3 monitors the processing context of another processing element PE4 independently from the control unit CU. Therefore, the processing element PE3 can calculate a coefficient for the quantization table. Therefore, the JPEG output can be adjusted independently from the control unit CU. The value of the transmission bit rate of Huffman encoding is received through the control line CTLN by the processing element PE3 for DCT and quantization. Therefore, the data processing is not interrupted.

(Program)

A program with which the distributed processing system according to the above described embodiments is executed may be configured as follows.

The program that causes a computer to execute a distributed processing method using a control unit and a plurality of processing elements may include a control information sending and receiving function of sending and receiving control information between the control unit and the processing elements, and a processed data transmitting function of transmitting data to be processed from at lest one of the control unit and a processing element to a processing element connected thereto, the processed data transmitting function being independent from the control information sending and receiving function, and cause the computer to execute a data processing function of processing input data and outputting the processed data in the processing element, a function of receiving a processing content changing condition and processing content changing information by the control information sending and receiving function and monitoring processing context, and a processing content changing function of changing the content of processing in the processing element based on the processing content changing information when the processing context meets the processing content changing condition.

All or part of the program for executing the above-described operation is recorded or stored in a portable medium such as a flexible disk or a CD-ROM, or a storing apparatus such as a hard disk drive. The program is read by a computer, and all or part of the operation is executed. All or part of the program can be distributed or provided through a communication network. A user can realize the distributed processing system according to the present invention without difficulty by downloading the program through the communication network and installing it to a computer or by installing the program to a computer from a recording medium.

As described above, the present invention can suitably be applied to a distributed processing system in which a processing flow or the content of processing can be changed flexibly in accordance with the situation.

The present invention can advantageously provide a distributed processing system in which the processing paths between processing elements and the processing content of the processing element can be changed easily and efficiently, and a control unit, a processing element, a distributed processing method, and a program for the distributed processing system.

What is claimed is:

1. A distributed processing system that has a control unit and a plurality of processing elements, comprising:
a control line through which control information is sent and received between the control unit and the processing elements; and
a data line through which data to be processed is transmitted from at least one selected from the control unit and the processing elements to the processing element connected thereto, the data line being independent from the control line,
wherein the processing element has a processing content changing section that changes the content of processing in the processing element using processing content changing information received through the control line when a monitored processing context of the processing element meets a processing content changing condition received through the control line.

2. A distributed processing system according to claim 1, wherein
the processing content changing information comprises a computation parameter,
the processing content changing condition comprises a computation parameter changing condition concerning changing of the computation parameter, and
the processing content changing section changes the computation parameter held in the processing content changing section when the processing context meets the computation parameter changing condition.

3. A distributed processing system according to claim 2, wherein the control unit generates and/or selects the computation parameter and the computation parameter changing condition based on the control information received from the processing element.

4. A distributed processing system according to claim 3, wherein the control unit receives dynamic control information that may be changed during the execution of operation, from the processing element.

5. A distributed processing system according to claim 3, wherein the control unit receives static control information that will not be changed during the execution of operation, from the processing element.

6. A distributed processing system according to claim 2, wherein the control unit generates and/or selects the computation parameter changing condition determined based on a processing status of the processing element.

7. A distributed processing system according to claim 1, wherein
the processing element further includes at least one of a data receiving section and a data transmitting section that selectively connect the data line with an output/input of a data processing section,
the processing content changing information comprises data line information,
the processing content changing condition comprises a data line changing condition concerning changing of the data line information, and
the processing content changing section changes a connection between the data line and the input/output of the data processing section based on the data line information when the processing context meets the data line changing condition.

8. A distributed processing system according to claim 7, wherein
the control unit generates and/or selects data line information for changing an input source processing element and/or an output destination processing element of the processing element to another processing element, and
the processing content changing section changes the input source and/or the output destination based on the data line information when the processing context meets the data line changing condition.

9. A distributed processing system according to claim 7, wherein
the control unit generates and/or selects data line information for adding another different processing element as an output destination of the processing element,
the processing content changing section adds the processing element as an output destination based on the data line information when the processing context meets the data line changing condition, and
a data transmitting section that outputs the operation result to a plurality of the processing elements is provided.

10. A distributed processing system according to claim 7, wherein
the control unit generates and/or selects data line information for adding another different processing element as an input source of the processing element,
the processing content changing section adds the processing element as an input source based on the data line information when the processing context meets the data line changing condition, and
a data receiving section that integrates the inputs from a plurality of the processing elements is provided.

11. A distributed processing system according to claim 7, wherein
the control unit generates and/or selects data line information for deleting at least one of input source and/or output destination processing elements of the processing element, and
the processing content changing section deletes an input source and/or an output destination based on the data line information when the processing context meets the data line changing condition.

12. A distributed processing system according to claim 7, wherein the control unit generates and/or selects the dateline information and the data line changing condition based on the control information received from the processing element.

13. A distributed processing system according to claim 12, wherein
the control unit receives dynamic control information that may be changed during the execution of computation from the processing element, and
the control unit generates and/or selects the data line information and the data line changing condition based on the dynamic control information.

14. A distributed processing system according to claim 12, wherein the control unit receives static control information that will not be changed during the execution of computation from the processing element, and the control unit generates and/or selects the data line information and the data line changing condition based on the static control information.

15. A distributed control system according to any one of claims 7 to 14, wherein the control unit generates and/or selects a data line changing condition for determining an output destination based on an input source of the processing element.

16. A distributed control system according to claim 7, wherein the control unit generates and/or selects a data line changing condition for determining an output destination based on a result of computation in the processing element.

17. A distributed control system according to claim 7, wherein
the control unit sends at least one of an input source, an output destination, and a connection relation between the input source and the output destination of the processing element as data line information, and
the processing element changes at least one of the input source, the output destination, and the connection relation between the input source and the output destination of the processing element based on the data line information.

18. A distributed control system according to claim 1, wherein the processing context is information on the processing element.

19. A distributed control system according to claim 1, wherein the processing context is information on another processing element different from the processing element.

20. A distributed control system according to claim 1, wherein the control unit holds all or part of the control information, selects the control information, and sends the control information to the processing element.

21. A distributed control system according to claim 1, wherein
the control unit receives information on all or part of control information from a user, and
the control unit sends the control information to the processing element based on the information from the user.

22. A control unit that controls two or more processing elements to cause them to perform distributed processing and is connected to the processing elements, comprising:
a control line through which control information is sent and received between the control unit and the processing elements; and
a data line through which data to be processed is transmitted to the processing element connected to the control unit, the data line being independent from the control line,
wherein the control unit sends a processing content changing condition and processing content changing information to the processing element through the control line.

23. A processing element that is connected to two or more processing elements and performs distributed processing, comprising:
a control line through which control information is sent and received between the processing element and a control unit; and
a data line through which data to be processed is transmitted to the processing element from at least one selected from the control unit and the processing elements, the data line being independent from the control line, wherein
the processing element has a data processing section that processes input data and outputs the processed data,
the processing element receives a processing content changing condition and processing content changing information through the control line and monitors an information context concerning processing, and
the processing element has a processing content changing section that changes the content of processing in the processing element based on the processing content changing information when the information concerning processing meets the processing content changing condition.

24. A distributed processing method using a control unit and a plurality of processing elements, comprising:
a control information sending/receiving step in which control information is sent and received between the control unit and the processing elements;
a processed data transmission step in which data to be processed is transmitted from at least one selected from the control unit and the processing elements to the processing element connected thereto, the processed data transmission step being independent from the control information sending/receiving step;
a data processing step in which input data is processed in and output from the processing element;
a step in which a content changing condition and processing content changing information are received by the control information sending/receiving step and a processing context is monitored; and
a processing content changing step in which the content of processing in the processing element is changed based on the processing content changing information when the processing context meets the processing content changing condition.

25. A program for causing a computer to execute a distributed processing method using a control unit and a plurality of processing elements, comprising:
a control information sending/receiving function by which control information is sent and received between the control unit and the processing elements; and
a processed data transmission function by which data to be processed is transmitted from at least one selected from the control unit and the processing elements to the processing element connected thereto, the processed data transmission function being independent from the control information sending/receiving function, wherein the program causes the computer to executes the following functions:
a data processing function by which input data is processed in and output from the processing element;
a function by which a content changing condition and processing content changing information are received by the control information sending/receiving function and a processing context is monitored; and
a processing content changing function by which the content of processing in the processing element is changed based on the processing content changing information when the processing context meets the processing content changing condition.
